(19) United States
(12) Patent Application Publication
(10) Pub. No.: US 2022/0356358 A1
(43) Pub. Date: Nov. 10, 2022

(54) COMPOSITION AND COMPOSITE MOLDED ARTICLE CONTAINING SAME

(71) Applicant: Idemitsu Kosan Co.,Ltd., Chiyoda-ku (JP)

(72) Inventors: Hiroshi YASUDA, Ichihara-shi (JP); Shigekazu TOMAI, Sodegaura-shi (JP)

(73) Assignee: Idemitsu Kosan Co.,Ltd., Chiyoda-ku (JP)

(21) Appl. No.: 17/626,952

(22) PCT Filed: Jul. 16, 2020
(86) PCT No.: PCT/JP2020/027624

§ 371 Date: Jul. 13, 2022

(30) Foreign Application Priority Data
Jul. 19, 2019 (JP) 2019-134060

(51) Int. Cl. C09D 5/08; C09D 7/61; C09D 179/04; C09D 179/02; C09D 181/00; C08K 3/04

(52) U.S. Cl. CPC C09D 5/08; C09D 7/61; C09D 179/04; C09D 179/02; C09D 181/00; C08K 3/04

(57) ABSTRACT

A composition having a carbon material and a redox substance with a redox potential of −0.2 (V vs. SHE) or higher and 1.5 (V vs. SHE) or lower. A composition having a carbon material that is a carbon fiber. A composition where the carbon fiber is in a form of a chopped strand, roving, textile, non-woven fabric, or unidirectional material.

### TECHNICAL FIELD

The inventor relates to a composition capable of preventing galvanic corrosion and increasing productivity, and a composite molded body containing the same.

### BACKGROUND ART

In order to increase fuel efficiency of automobiles and aircraft, attempts are being made to reduce weight thereof by replacing metal components with fiber-reinforced plastics. Also for industrial parts such as robots, for example, in order to reduce the inertial force of an arm portion, weight reduction using fiber-reinforced plastic has been attempted.

Carbon fibers are known as fibers used in fiber-reinforced plastics. However, when a carbon fiber-reinforced plastic is jointed to a metal component by, for example, insert making a the like, galvanic corrosion easily occurs due the conductivity of the carbon fibers.

Patent Document 1 discloses an at for preventing galvanic corrosion when carbon fiber-enforced plastic is applied to an inner panel of an automobile door.

Patent Document 2 discloses an art relating to joint of a carbon fiber-reinforced plastic and a metal in various moving objects such as an aircraft.

Patent Document 3 discloses an art related to a primer coating of a steel material. In a primer coating agent containing zinc powder for exhibiting a sacrificial antirust effect, conductivity is imparted to the primer coating by blending a conductive material into the coating agent in order to have a sacrificial antirust effect exhibited not only on the zinc powder directly contacting the steel material but also on the zinc powder not contacting the steel material.

### RELATED ART DOCUMENTS

### Patent Documents

[Patent Document 1] JP2017-109715A1

[Patent Document 2] JP 2018-187918 A1

[Patent Document 3] JP 201934289A1

### SUMMARY OF THE INVENTION

The arts of Patent Documents 1 and 2 avoid direct contact between a metal and a carton fiber-reinforced plastic to prevent galvanic corrosion. In this care, since an insulator or the like has to be provided between the metal and the carbon fiber-reinforced plastic, so that productivity is limited.

The art of Patent Document 3 is an art of primer coating antirust. Therefore, Patent Document 3 does not recognize the problem of preventing galvanic corrosion used by direct contact between a carbon fiber-reinforced plastic and a metal, and does not solve such a problem. In other words, the at Patent Document 3 specifically discloses that zinc powder s essentially contained in a primer meting, and that zinc powder and carbon nanomaterial are used m combination, or that zinc powder and a conductive polymeric material are used in combination, but in such a configured, when all of the zinc powder is oxidized, the anticorrosion effect is lost, so that it is difficult to prevent the galvanic corrosion described above over a long period of time.

It is an oiled of the invention to provide a composition capable of preventing galvanic corrosion over a long period dame and increasing productivity, and a composite molded body containing the same.

According to the invention, the following composition and the like are provided

1. A composition comprising a carbon material and a redox substance having a redox potential of −0.2 (V vs. SHE) or higher and 1.5 (V vs. SHE) or lower.
2. The composition according to 1, wherein the carbon material is a carbon fiber.
3. The composition according to 2, wherein the carbon fiber is in one or more forms selected from the group consisting of a chopped strand, a roving, a textile, a non-woven fabric, and a unidirectional material.
4. The composition according to any one of 1 to 3, wherein the radio substance is a polymer.
5. The composition according in anyone of 1 to 4, wherein the redox substance is one or more selected from the group consisting of a polypyrrole-based polymer, a polythiophene-based polymer, and a polyaniline-based polymer.
6. The composition according to any of 1 to 5, further comprising a polymeric material having no redox function or having a redox potential outside the ranges of −2.0 (V vs. SHE) or higher and 1.5 (V vs. SHE) a lower.
7. The composition according to 6, wherein the polymeric material is one or more selected from the group consisting of an epoxy resin, a polyamide resin, a polyimide resin, an acrylic resin, unsaturated polyester, polyurethane, polypropylene, polycarbonate, polystyrene, aromatic polyether, polyarylene sulfide, polysulfone, polyethersulfone, and polyetherimide.
8. The composition according to 6 or 7, wherein the polymeric material comprises a pol carbonate-polyorganosiloxane copolymer.
9. The composition warding in any one of in 8, wherein the polymeric material comprises syndiotactic polystyrene.
10. The composition according to any one of 6 in 9, wherein the polymeric material comprises polypropylene.
11. The composition according to any one of 1 to 10, further comprising a solvent.
12. The composition according to 11, wherein the solvent comprises a compound having a hydroxy group and a butoxy group.
13. The composition according to 12, wherein the compound is one or more selected from the group consisting of propylene glycol mono-n-butyl ether, propylene glycol mono-tert-butyl ether, propylene glycol mono-isobutyl ether, ethylene glycol mono-n-butyl ether, ethylene glycol mono-tert-butyl ether, and ethylene glycol mono-isobutyl ether.
14. A molded body, comprising the composition according to anyone of 1 to 10.
15. An antirust paint, comprising the composition according to any one 11 to 13.
16. A composite molded body, comprising a first portion and a second portion, wherein

the first portion comprises a metal,

the second portion comprises the composition according in any one of 1 to 10, and

the first portion and the second portion are in contact with each other at least in part.

17. The composite molded body according to 16, wherein the first portion comprises a metal or alloy comprising one or more selected from the group consisting of iron, aluminum, zinc, magnesium, and copper.
18. An automobile part, comprising the composite molded body according to 16 or 17.
19. An aircraft part, comprising the composite molded body according to 16 or 17.
20. A part for an industrial machinery, comprising the composite molded body according to 18 or 17.
21. A method of producing the composite molded body according to 16 or 17, comprising

a step of adding the composition to the first portion.

22. The method of producing a composite molded body according to 21, wherein the composition further comprises a solvent.
23. The method of producing a composite molded body according to 21 or 22, wherein in the step, the composition is added to the first portion by one or more seeded from the group consisting of a method of applying the composition to the first portion, a method of immersing the composition into the first portion, and a method of performing insert-molding using the composition for the first portion.
24. A method of suppressing corrosion era metal portion, comprising

a step of forming a composition portion comprising the composition according in any one of 1 to 10 to contact with the metal portion at least in part.

25. The method according to 24, wherein in the step, the composition portion is molded to contact with the metal portion at least in part.
26. The method according to 24 or 25, wherein the metal portion comprises a metal or alloy comprising one or more selected from the group consisting of iron, aluminum, zinc, magnesium, and copper.
27. The method according to anyone of 24 to 26, wherein in the step, the composition further comprising a solvent is added to the metal portion.
28. The method according to any one of 24 to 27, wherein in the step, the composition is added to the metal portion by one or more selected from the group consisting of a method of applying the composition to the metal portion, a method or immersing the metal portion into the compassion, and a method of performing insert-molding using the composition for the metal portion.
29. A sizing material for carbon fibers, comprising a redox substance having a redox potential of −0.2 (V vs. SHE) or higher and 1.5 (V vs. SHE) or lower.
30. The sizing material for carbon fiber according to 29, wherein the redox substance is a polymer.
31. The sizing material for carbon fibers according to 29 or 30, wherein the redox substance is one or more selected from the group consisting of a polypyrrole-based polymer, a polythiophene-based polymer, and a polyaniline-based polymer.
32. The sizing material for carbon fibers according to any one of 29 to 31, further comprising a polymeric material having no redox function or having a redox potential outside the ranges of −2.0 (V vs. SHE) or higher and 1.5 (V vs. SHE) or lower.
33. The sizing material for carbon fibers according to 32, wherein the polymeric material is one or more selected from the group consisting of an epoxy resin, a polyamide resin, a polyimide resin, an acrylic resin, an unsaturated polyester, polyurethane, polypropylene, polycarbonate, polystyrene, aromatic polyether, polyarylene sulfide, polysulfone, polyethersulfone, and polyetherimide.
34. Carbon fibers with a strung material, wherein the sizing material for cabal fibers according to any one of 29 to 33 is added.
35. The carbon teem with a sizing material according to 34, which is in one or more forms selected from the group consisting of a chopped strand, a roving, a woven fabric, a nonwoven fabric, and a unidirectional material.
36. A polymeric material composition, comprising the carbon fibers win a sizing material according to 34 or 35.
37. A composite molded body, comprising a polymeric material portion and a metal portion, wherein

the polymeric material portion comprises the polymeric material composition according to 36, and

the polymeric material portion and the metal portion are in contact with each other at least in part.

38. A method for fabricating the composition molded body according to 37, comprising

a step of imparting the polymeric material composition according to 36 to the metal portion.

39. A method of suppressing corrosion of a metal portion, comprising

a step of adjoining a polymeric material portion comprising the polymeric material composition according to 36 to contact with the metal portion at least in part.

According to the invention, it is possible to provide a composition capable of preventing galvanic corrosion over a ling period of time and increasing productivity, and a composite molded body containing the same.

### BRIEF DESCRIPTION OF THE DRAWINGS

FIG. 1 is a schematic diagram for explaining automobile parts.

FIG. 2 is a schematic diagram for explaining automobile parts.

FIG. 3 is a schematic diagram for explaining automobile parts.

FIG. 4 is a schematic diagram for explaining automobile parts.

FIG. 5 is a photograph showing the rust occurrence situation in Example 2.

FIG. 6 is a photograph showing the rust occurrence situation in Comparative Example 2.

FIG. 7 is a schematic diagram for explaining a method of brine emersion test.

FIG. 8 is a photograph showing the results of the brine immersion test (Example 3 and Comparative Example 3).

### MODE FOR CARRYING OUT THE INVENTION

### 1. Composition

The composition according to one aspect of the invention (hereinafter, sometimes referred to as “composition A”) contains a carbon material and a redox substance having a redox potential of −0.2 (V vs. SHE) or higher and 1.5 (V vs. SHE) or lower (hereinafter, sometimes referred to simply as “redox substance”). By this constitution, the composition has an excellent function of preventing galvanic corrosion for a long period of time and has an effect of increased productivity.

According to the embodiment, by allowing the carbon material and the redox substance to coexist in the composition A, galvanic corrosion generated at the contact site between the composition A and the meal can be prevented over a long period of time. As reason why such an effect is exhibited, it is estimated that an oxide coating is formed on the metal surface, and so on.

Further, according to the embodiment, an insulator or the like for preventing galvanic corrosion between the metal and the composition A has not to necessarily provide, so that productivity can be increased.

Further, according to the embodiment, by using the carbon material and the redox substance in combination, it is possible to achieve both increase and mechanical properties (e.g., strength, etc.) by the carbon material and prevention of galvanic corrosion caused by direct contact between the carbon material and the metal. Such an effect is exhibited without relying on the zinc powder described in Patent Document 3. Accordingly, in the embodiment, it is not necessary to include zinc powder in the composition. According to the embodiment, it is possible to form a suitable oxide coating on the metal surface without containing zinc powder in the composition.

When zinc powder is contained in the composition A, it is preferable that the content thereof be small, for example, the content may be smaller than 70% by mass, 60% by mass or smaller, 50% by mass or smaller, 40% by mass or smaller, 30% by mass or smaller, 20% by mass or smaller, 10% by mass or smaller, 5% by mass or smaller, 3% by mass or smaller, 1% by mass or smaller, 0.5% by mass or smaller, or 0.1% by mass or smaller. This content may be a content based on the composition A containing a solvent, or may also be a content based on the composition A without a solvent or the composition A after removing a solvent.

Sacrificial anticorrosion effect by zinc powder is difficult to prevent galvanic corrosion for a long period of time because when all of the zinc powder is oxidized, the effect is lost. ON the other hand, the oxide coating which is considered to be formed on the metal surface according to the embodiment maintains the effect of preventing galvanic corrosion as long as the oxide coating continues to exist. Therefore, it is presumed that galvanic corrosion is prevented for a long time.

According to the embodiment, other components combined with the composition can be reinforced by the carbon material contained in the composition. At this time, even when the other component contains a metal and the metal contacts with the carbon fibers in the composition, galvanic corrosion of the metal can be prevented over a long period of time as described above.

### (Carton Material)

The carbon material is not particularly limited, and for example, a carbon material having a hexagonal lattice structure of carbon atoms by SP² bonding (graphene structure) may be used. Such a carbon material may have conductivity due to the graphene structure. The volume resistivity of such a carbon material may be, for example, 10¹⁰ Ω·cm or lower, 10⁵ Ω·cm or lower, 10⁰ Ω·cm or lower, or 10³ Ω·cm or lower. Here, the volume resistivity of the carbon material is a value measured at room temperature (23° C.) by the four-probe method, and when the carbon material is a carbon fiber, the volume resistivity is measured in accordance with “Carbon fibre-Determination of volume resistivity” in JIS R 7609 (2007).

In one embodiment, the carbon material is one a more selected from the group consisting of pitch-based carbon fibers, PAN-based carbon fibers, vapor grown carbon fibers, carbon black, graphite, carbon nanotube, graphene, activated carbon, and activated carbon fibers.

The carbon material is preferably carbon fibers. The carbon tem preferably have one a more forms selected from the group consisting of a chopped strand, a roving, a textile, a non-woven fabric, and a unidirectional material. Here, the “form” of carbon fibers may be a form in which an aggregate of carbon fibers takes on as a whole.

### (Redox Substance)

As the redox substance, a redox substance having a redox potential of −0.2 (V vs. SHE) or higher and 1.5 (V vs. SHE) or lower (hereinafter, also simply referred to as a“redox substance”) may be used. The rectos potential is measured by means of a method using a three-electrode system of a working electrode, a reference electrode, and a counter electrode, in which an object substance (compound) is dispersed or dissolved in an electrolyte solution dissolving a supporting electrolyte having a concentration of 0.1 mol/L, and the natural potential of the working electrode relative to the reference electrode is read. In this case, gold is used as the working electrode. The measurement temperature is set to be 23° C. If the object substance has poor solubility, the working electrode may be coated with the substance and immersed in the electrolyte solution. When a reference electrode other than the standard hydrogen electrode (SHE) is used, the potential relative to the hydrogen electrode potential (V vs. SHE) is obtained by subtracting, for example, 0.24 V in the case of saturated calomel electrode or 0.22 V in the case of a silver chloride electrode from the potential measured, respectively (see the Electrochemistry Handbook, 4th edition, p. 77, edited by the Electrochemical Society of Japan).

The redox potential of the redox substance may be −0.2 (V vs. SHE) or higher, −0.15 (V vs. SHE) or higher, −0.1 (V vs. SHE) or higher, −0.05 (V vs. SHE) or higher, or 0 (V vs. SHE) a higher and may be 1.5 (V vs. SHE) a lower, 1.3 (V vs. SHE) or lower, 1.0 (V vs. SHE) or lower, or 0.8 (V vs. SHE) or lower.

In one embodiment, the redox substance is an organic compound. In one embodiment, the redox substance is an organic compound that does not contain a metal element in the molecular.

In one embodiment, the molecular weight of the redox substance is 300 or more, 500 or more, or 700 or more. The upper limit is not particularly limited and may be, for example, 100,000 or less.

In one embodiment, the redox substance is a polymer (hereinafter, a redox substance which is a polymer may be referred to as a “redox polymer”). Specific examples of the redox polymer include polyacetylene-based polymers such as polyacetylene, polymethylacetylene, polyphenylacetylene, polyfluoroacetylene, polybutylacetylene, polymethylphenylacetylene, and the like; polyphenylene-based polymers such as polyorthophenylene, polymetaphenylene, polyparaphenylene and the like; polypyrrole-based polymers such as polypyrrole, poly(3-methylpyrrole), poly(3-ethylpyrrole), poly(3-dodecylpyrrole), poly(3,4-dimethylpyrrole), poly(3-methyl-4-dodecylpyrrole), poly(N-methylpyrrole), poly(N-dodecylpyrrole), poly(N-methyl-3-methylpyrrole), poly(N-ethyl-3-dodecylpyrrole), poly(3-carboxypyrrole) and the like; polythiophene-based polymers such as polythiophene, poly(3-methylthiophene), poly(3-ethylthiophene), poly(3,4-dimethylthiophene), poly(3,4-diethylthiophene), poly(3,4-ethylenedioxythiophene) and the like; polyfuran; polyselenophene; polyisothianaphthene; polyphenylene sulfide; polyaniline-based polymers such as polyaniline, poly(2-methylaniline), poly(2-ethylaniline), poly(2,6-dimethylaniline) and the like; polyphenylene vinylene, polythiophene vinylene, polyperinaphthalene, polyanthracene, polynaphthalene, polypyrene, polyazulene, and derivatives of these polymers, and the like.

The redox substance may be used alone a in combination of two or more thereof.

The redox substance is preferably one or more selected from the group consisting of a polypyrrole-based polymer, a polythiophene-based polymer and a polyaniline-based polymer, and further preferably a polyaniline-based polymer.

In one embodiment, the redox substance, particularly the redox polymer, may be doped with a dopant. The dopant doping to the redox substance can be confirmed ultraviolet-visible-near infrared spectroscopy or X-ray photoelectron spectroscopy.

Specific examples of the dopant include halide ions such as chloride ion, a bromide ion, an iodide ion and the like; a perchlorate ion; a tetrafluoroborate ion; a hexafluoride arsenate ion; a sulfate ion; a nitrate ion; a thiocyanate ion; a hexafluoride silicate ion; phosphate ions such as a phosphate ion, a phenyl phosphate ion, a hexafluoride phosphate ion and the like; a trifluoroacetate ion; alkylbenzene sulfonate ions such as a tosylate ion, an ethylbenzene sulfonate ion, a dodecylbenzene sulfonate ion and the like; alkyl sulfonate ions such as methylsulfonate ion, an ethylsulfonate ion, an ion of sulfosuccinate derivative; a dibenzofuran sulfonate ion; a naphtharene sulfonate ion; polymeric ions such as polyacrylate ion, a polyvinylsulfonate ion, a polystylene sulfonate ion, a poly(2-acrylamide-2-methylpropanesulfonate) ion and the like; etc. In addition to the above ions, an un-ionized element or compound may be contained in the dopant.

The dopant may be used atone or in combination of two or more thereof.

Among the above dopants, sulfosuccinate derivatives (including ions) such as polystyrenesulfonic acid and di-2-ethylhexylsulfosuccinic acid are preferred.

The amount of docent doped into the redox polymer is preferably from 0.1 to 1.0, and more preferably from 0.15 to 0.75, in terms of a dopant ratio (expressed as a ratio expressed by the number of moles of the dope/the numbers of moles of the monomer unit constituting the redox polymer).

The dopant ratio refers to the molar ratio of the dopant (courier anion) to monomer units constituting the redox polymer. For example, a dopant ration of 0.5 for a polyaniline complex containing unsubstituted polyaniline and a dopant means that one dopant is doped per two monomer unit molecules of polyaniline.

The dopant ratio can be calculated if the number of moles of the dopants and the number of moles of the monomer units constituting polyaniline in the polyaniline complex can be measured. For example, when the dopant is an organic sulfonic acid, the number of moles of sulfur atom derived from the dopant and the number of moles of nitrogen atom derived from the monomer unit of polyaniline can be quantified by an organic element analytical method, and the dopant ration can be calculated by determining the ration of these values. However, the method of calculating the dopant ratio is not limited to this method.

### (Polyaniline-Based Polymer)

Hereinafter, a polyaniline-based polymer will be explained in more detail.

The polyaniline-based polymer may be a substituted or unsubstituted polyaniline.

The substituted or unsubstituted polyaniline may be used alone (that means the state in which a “polyaniline complex” described later is not formed), but is preferable that the substituted or unsubstituted polyaniline is contained in the composition A as a polyaniline complex doped with a dopant.

The weight-average molecular weight (hereinafter also simply referred to a “molecular weight”) of the polyaniline is 20,000 or more. The molecular weight is preferably 20,000 to 500,000, more preferably 20,000 to 300,000, and still more preferably 20,000 to 200,000. The weight-average molecular weight means the molecular weight of the polyaniline, not that of the polyaniline complex.

The molecular weight distribution of the polyaniline is preferably 1.5 or more and 10.0 or less. From the viewpoint of conductivity, it is preferable that the molecular weight distribution of polyaniline is smaller, but from the viewpoint of solubility in a solvent, it may be preferable that the molecular weight distribution of polyaniline is wider in some cases.

The molecular weight and the molecular weight distribution of polyaniline are determined by gel permeation chromatography (GPC) in terms of polystyrene.

Examples of the substituent of the substituted polyaniline include straight-chain or branched hydrocarbon groups such as a methyl group, an ethyl group, a hexyl group, an octyl group and the like; alkoxy groups such as a methyoxy group, an ethoxy group and the like; aryloxy groups such as a phenoxy group and the like; and halogenated hydrocarbon groups such as an trifluoromethyl group (—CF₃ group) and the like.

The polyaniline is preferably unsubstituted polyaniline from the viewpoint of versatility and economic efficiency.

The substituted or unsubstituted polyaniline is preferably ones obtained by polymerization in the presence of an acid containing no chlorine atom. The acid containing no chlorine atom includes acids composed of atoms belonging, for example, to Groups 1 to 16 and 18. Specific examples thereof include phosphoric acid. Examples of the polyaniline obtained by polymerization in the presence of the acid containing no chlorine atom include ones obtained by polymerization in the presence of phosphoric acid.

The used polyaniline obtained in the presence of the acid containing no chlorine atom allows to further reduce the chlorine content in the polyaniline complex.

The substituted or unsubstituted polyaniline is preferably a polyaniline complex doped by a dopant. The use of a the polyaniline complex allows to increase solubility in a solvent and to facilitate homogeneous mixing thereof in a carbon material.

Examples of the dopant of the polyaniline complex include, for example, Bronsted acid ions arising from Bronsted acids or salts of Bronsted acid, preferably organic acid ions arising from organic acids or salts of organic acids, and more preferably organic acid ions arising from the compound represented by the following formula (I) (proton donor).

In the invention, there are the case where the dopant may be described as a specific acid and the case where the dopant may be described as a specific salt, both the cases mean that a specific acid ion arising from the specific acid or the specific salt is doped into the π-conjugated polymer.

M(XARₙ)ₘ (I)

M in the formula (I) is a hydrogen atom, an organic tee radical, or an inorganic free radical.

Examples of the organic free radical include a pyridinium group, an imidazolium group, and an anilinium group, and the like. Examples of the inorganic free radical include ions of lithium, sodium, potassium, cesium, ammonium, calcium, magnesium, iron, and the like.

X in the formula (I) is an anionic group, for example, a —SO₃⁻ group, a —PO₃²⁻ group, a —PO₂(OH)⁻ group, a —OPO₃²⁻ group, a —OPO₃(OH)⁻ group, a —COO⁻ group, and the like, and is preferably a —SO₃⁻ group.

A in the formula (I) is a substituted or unsubstituted hydrocarbon group (including, for example, 1 to 20 carbon atoms).

The hydrocarbon gap is a open-chain or cyclic saturated aliphatic hydrocarbon group, an open-chain or cyclic unsaturated aliphatic hydrocarbon group, or an aromatic hydrocarbon group.

Examples of the open-chain saturated aliphatic hydrocarbon group include a straight-chain or branched alkyl group (including, for example, 1 to 20 carbon atoms). Examples of the cyclic saturated aliphatic hydrocarbon group include cycloalkyl groups (including, for example, 3 to 20 carbon atoms) such as a cyclopentyl group, a cyclohexyl group, a cycloheptyl group, a cyclooctyl group, and the like. The cyclic saturated aliphatic hydrocarbon group may be one fused of a plurality of cyclic saturated aliphatic hydrocarbon groups. Examples thereof include a norbornyl group, an adamantyl group, a fused adamantyl group and the like. Examples of the open-chain unsaturated aliphatic hydrocarbon group (including, for example, 2 to 20 carbon atoms) include a straight-chain or branched alkenyl group. Examples of the cyclic unsaturated aliphatic hydrocarbon group (including, for example, 3 to 20 carbon atoms) include a cyclic alkenyl group. Examples of the aromatic hydrocarbon group (including, for example, 6 to 20 carbon atoms) include a phenyl group, a naphthyl group, an anthracenyl group and the like.

The substituent in the case where A is a substituted hydrocarbon group is an alkyl group (including, for example, 1 to 20 carbon ohms), a cycloalkyl group (including, for example, 3 to 20 carbon atoms), a vinyl group, an ally group, an aryl group (including, for example, 6 to 20 carbon atoms), an alkoxy group (including, for example, 1 to 20 carbon atoms), a halogen atom, a hydroxy group, an amino group, an imino group, a nitro group, a silyl group, or an ester bond-containing group,

R in the formula (I) is bonded with A, and is —H or a substituent represented by —R¹, —OR¹, —COR¹, —COOR¹, —(C═O)—(COR¹), or —(C═O)—(COOR¹), wherein R¹ is a hydrocarbon group which may be substituted by a substitutent, a silyl group, an alkylsilyl group, a —(R²O)ₓ—R³ group, or a —(OSiR₃²)ₓ—OR³ group. R² is an alkylene group, R³ is a hydrocarbon group, and x is an integer of 1 or more. When x is 2 or more, a plurality of R²'s may be the same as or different from each other, and a plurality of R³'s may be the same as or different from each other.

Examples of the hydrocarbon group for R¹ (including, for example, 1 to 20 carbon atoms) include a methyl group, an ethyl group, a butyl group, a pentyl group, a hexyl group, a heptyl group, an octyl group, a nonyl group, a decyl group, a dodecyl group, a pentadecyl group, an eicosanil group, and the like. The hydrocarbon group may be straight-chain or may be branched.

The substituent of the hydrocarbon group is an alkyl group (including, for example, 1 to 20 carbon atoms), a cycloalkyl group (including, for example, 3 to 20 carbon atoms), a vinyl group, an allyl group, an aryl group (including, for example, 6 to 20 carbon atoms), an alkoxy group (including, for example, 1 to 20 carbon atoms), a halogen group, a hydroxy group, an amino group, an amino group, a nitro group, or an ester bond-containing group. The hydrocarbon group for R³ is the same as that for R¹.

Examples of the alkylene group for R² (including, for example, 1 to 20 carbon atoms) include, for example, a methylene group, an ethylene group, a propylene group, and the like.

n in the formula (I) is an integer of 1 or more. When n is 2 or more, a plurality of R's may be the same as or different from each other.

m in the formula (I) is an numerical value dividing the valence of M by the valence of X.

As the compound represented by the formula (I), dialkylbenzenesulfonic acid, dialkylnaphthalenesulfonic acid, and a compound containing two or more ester bonds are preferred.

As the compound containing two or more ester bonds is more preferably sulfophthalic ester a compound represented by the following formula (II):

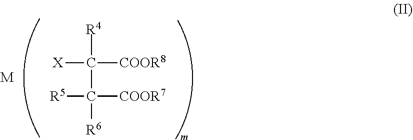

In the formula (II), m, M, and X are the same as in the formula (I). X is preferably a —SO₃⁻ group.

R⁴, R⁵, and R⁶ are independently a hydrogen atom, a hydrocarbon group, or a R⁹₃Si— group. Three R⁹'s are independently a hydrocarbon group.

Examples of the hydrocarbon group for R⁴, R⁵ and R⁶, which are hydrocarbon groups, include a straight-chain or branched alkyl group including 1 to 24 carbon atoms, an aryl group containing an aromatic ring (including, for example, 6 to 20 carbon atoms), an alkylaryl group (including, for example, 7 to 20 carbon atoms), and the like.

Examples of the hydrocarbon group for R⁹ are the same as those for R⁴, R⁵, and R⁶.

R⁷ and R⁸ in the formula (II) are independently a hydrocarbon group or a —(R¹⁰O)_{q}—R¹¹ group. R¹⁰ is a hydrocarbon group or a silylene group, R¹¹ is a hydrogen atom, a hydrocarbon group, or a R¹²₃Si—, and q is an integer of 1 or more. Three R¹²'s are independently a hydrocarbon group.

Examples of the hydrocarbon group for R⁷ and R⁸ in the case where they are the hydrocarbon groups include a straight-chain or branched alkyl group including 1 to 24 carbon atoms, and preferably 4 or more carbon atoms, an aryl group containing an aromatic ring (including, for example, 6 to 20 carbon atoms), an alkylaryl group (including, for example, 7 to 20 carbon atoms), and the like. Specific examples thereof include a butyl group, a pentyl group, a hexyl group, an octyl group, a decyl group, and the like, all of which are straight-chain or branched.

Examples of the hydrocarbon group for R¹⁰ in R⁷ and R⁸ in the case where R¹⁰ is the hydrocarbon group include, for example, a straight-chain or branched alkylene group including 1 to 24 carbon atoms, an arylene group containing an aromatic ring (including, for example, 6 to 20 carbon atoms), an alkylarylene group (including, for example, 7 to 20 carbon atoms), and an arylalkylene group (including, for example, 7 to 20 carbon atoms). In addition, the hydrocarbon groups each for R¹¹ and R¹² in R⁷ and Re in the case where R¹¹ and R¹² are the hydrocarbon groups are the same as those for R⁴, R⁵, and R⁶, and q is preferably 1 to 10.

Specific examples of the compound represented by the formula (II) in the case where R⁷ and R⁸ are —(R¹⁰O)_{q}—R¹¹ groups include two compounds represented by each of following formulas (II-1) and (II-2).

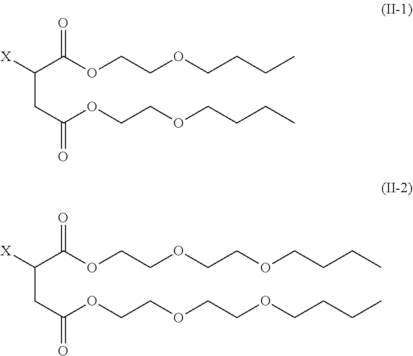

In the formulas (II-1) and (II-2), X is the same as in the formula (I).

It is further petered reed that the compound represented by the formula (II) is a sulfosuccinic acid derivative represented by the foaming formula (III).

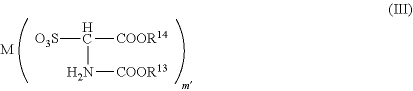

In the formula (III), M is the same as in the formula (I), m′ is the valence of M.

R¹³ and R¹⁴ are independently a hydrocarbon group or a —(R¹⁵O)ᵣ—R¹⁶ group. R¹⁵ is a hydrocarbon group or a silylene group, R¹⁶ is a hydrogen atom, a hydrocarbon group, or a R¹⁷₃Si— group, and r is an integer of 1 or more. Three R¹⁷'s are independently a hydrocarbon group. When r is 2 a more, a plurality of R¹⁸'s may be the same as or different from each other.

The hydrocarbon groups for R¹³ and R¹⁴ in the case where they are the hydrocarbon groups are the same as those for R⁷ and R⁸.

The hydrocarbon group for R¹⁵ in R¹³ and R¹⁴ in the case where R¹⁵ is the hydrocarbon gasp is the same as that for R¹⁰. In addition, the hydrocarbon groups for R¹⁶ and R¹⁷ in R¹³ and R¹⁴ in the case where R¹⁸ and R¹⁷ are the hydrocarbon groups are the same as those for R⁴, R⁵ and R⁶.

r is preferably 1 to 10.

Specific examples of the —(R¹⁵O)ᵣ—R¹⁶ groups for R¹³ and R¹⁴ are the same as the —(R¹⁰O)_{q}—R¹¹) groups for R⁷ and R⁸.

The hydrocarbon groups for R¹³ and R¹⁴ are the same as those for R⁷ and R⁸, and a butyl group, a hexyl group, a 2-ethylhexyl group, and a decyl group are preferred.

As the compound represented by the formula (I), di-2-ethylhexylsulfosuccinic acid and sodium di-2-ethylhexylsulfosuccinate (Aerosol OT) are preferred.

A dopant being doped into the substituted or unsubstituted polyaniline in the polyaniline complex can be confirmed by ultraviolet/visible/near-infrared spectroscopy or X-ray photoelectron spectroscopy, and the dopant can be used without any particular chemical structural limitation as long as the dopant has enough acidity to generate carriers in the polyaniline.

The doping ratio of the dopant to the polyaniline is preferably 0.35 or more and 0.65 or less, more preferably 0.42 or more and 0.60 or less, still more preferably 0.43 a more and 0.57 or less, and particularly preferably 0.44 or more and 0.55 or less.

The doping ratio is defied as (number of moles of the dopant doped into polyaniline)/(number of moles of monomer unit of polyaniline). For example, a doping ratio of 0.5 for a polyaniline complex containing attaining unsubstituted polyaniline and a dopant means that one dopant is doped with respect to tow monomer unit molecules of polyaniline.

The doping ratio can be calculated rite numbers of moles of the dopant and the monomer unit of the polyaniline in the polyaniline complex can be determined. For example, when the dopant is an organic sulfonic acid, the number of moles of the sulfur atom derived from the dopant and the number of moles of the nitrogen atom derived from the monomer unit of polyaniline are quantified by the organic elemental analysis method, and the ratio can be taken from these values to obtain a doping ratio. However, the method of calculating the doping ratio is not limited to this means.

The polyaniline complex may further contain phosphorus or may not contain phosphorus.

When the polyaniline complex contains phosphorus, the content of phosphorus is, for example, 10 ppm by mass or more and 5000 ppm by mass or toss.

The content of phosphorus can be measured by ICP emission spectrometry.

Further, the polyaniline complex preferably contains no Group 12 element (e.g., zinc) as an impurity.

The polyaniline complex can be produced in a well-known production method. For example, the polyaniline complex can be produced by chemical oxidative polymerization of a substituted or unsubstituted aniline in a two-liquid phase solution containing a proton donor, phosphoric acid, and an emulsifier different from the proton donor. The polyaniline complex can also be produced by adding an oxidative polymerization agent to a two-liquid phase solution containing a substituted or unsubstituted aniline, a proton donor, phosphoric acid, and an emulsifier different from the proton donor.

Here, “a two-liquid phase solution” means a solution having a state where two liquid phases incompatible will each other are present in the solution. For example, it means a solution in a state where “a phase of high polarity solvent” and “a phase of low polarity solvent” are present in the solution.

In addition, “the two-liquid phase solution” also included a solution in a state where one liquid phase is a continuous phase and the other liquid phase is a dispersed phase. Examples thereof include a solution in a state where “the phase of high polarity solvent” is the continuous phase and the “the phase of low polarity solvent” is the dispersed phase, and a solution in a state where “the phase of a low polarity solvent” is the continuous phase and the “the phase of a high polarity solvent” is the dispersed phase.

As such a high polarity solvent used in the above method for producing a polyaniline complex, water is preferred, and as such a low polarity solvent, for example, aromatic hydrocarbons such as toluene and xylene are preferred.

The proton donor is preferably a compound represented by the formula (I).

As the emulsifier, both ionic emulsifiers, in which the hydrophilic moiety is ionic, and nonionic emulsifiers, in which the hydrophilic moiety is nonionic, may be used, and the emulsifier may be used alone or in combination of two or more kinds.

As the oxidizing agent used in the chemical oxidative polymerization, peroxides such as sodium persulfate, potassium persulfate, ammonium persulfate, and hydrogen peroxide, ammonium dichromate, ammonium perchlorate, potassium iron(II) sulfate, iron(III) trichloride, manganese dioxide, iodic acid, potassium permanganate, iron paratoluenesulfonate, and the like can be used, and persulfates such as ammonium persulfate are preferable.

These may be used alone or in combination of two or more thereof.

### (Polymeric Material)

In one embodiment, the composition A further contains a polymeric material which do not have a redox function or which has a redox potential outside the ranges of −0.2 (V vs. SHE) or higher and 1.5 (V vs. SHE) or lower (hereinafter sometimes simply referred to as “the polymeric material”). The polymeric material can function as a binder between the carbon fibers.

In one embodiment, the polymeric material may have a volume resistivity higher than 1×10¹⁰ Ω·cm. The volume resistivity of the polymeric material is a value measured by the three-terminal method at 23° C. in accordance with JIS K6271:2008.

In one embodiment, the polymeric material contains a resin. Examples of the resin may include, for example, one or more selected from the group consisting of an epoxy resin, a polyamide resin, a polyimide resin, an acrylic resin, an unsaturated polyester, polyurethane, polypropylene, polycarbonate, polystyrene, an aromatic polyether, polyarylene sulfide, polysulfone, polyethersulfone, and polyetherimide.

The polymeric material may be a thermoplastic resin or a thermosetting resin. For example, the polyurethane may be a thermoplastic polyurethane or a thermosetting polyurethane. Also, the polymeric material may be a soft elastomer such as rubber or the like.

### (Epoxy Resin)

In one embodiment, the polymeric material contains an epoxy resin.

The epoxy resin may be a thermoplastic resin or a thermosetting resin.

When the epoxy resin is a thermosetting resin, an epoxy resin before curing may be a composition containing a main agent and a curing agent (generally, such a composition itself is conventionally referred to as an epoxy resin, but in this specification, it may be referred to as an “epoxy resin composition” in order to differentiate it from an epoxy resin after curing)

The main agent contains an epoxy compound. The epoxy compound is not particularly limited, and those known as the main agent of the epoxy resin can be used. Examples of the epoxy compound include a reactant of bisphenol A and epichlorohydrin, and the like. The property of the epoxy compound is not particularly limited, and may be a liquid or a solid at ordinary temperature (23° C.).

The curing agent can be classified depending on the type of the functional group (reactive group) for reacts with the epoxy group possessed by the epoxy compound, and examples thereof include an amine-based one and a carboxylic acid-based one. Any of the amine-based one, the carboxylic acid-based one, and the like is suitably used, and is preferably a carboxylic acid-based one. The curing agent may be any of the acidic one and the basic one. If it is the acidic curing agent such as a carboxylic acid-based one, elimination of the dopant contained in the redox substance is prevented, and the effect of the invention is more stably exhibited.

Example of the carboxylic acid-based curing agent include acid anhydrides, carboxylic acids having two or more carboxy groups, and blocked carboxylic acids. The blocked carboxylic acid is a compound having carboxy groups protected (blocked) by adding an alkyl vinyl ether to the carboxy groups of the carboxylic acid having two or more carboxy groups, and can be obtained, for example, as “NOFCURE (registered trademark) TN-5” manufactured by NOF CORPORATION.

Each of the main agent and the curing agent may be used alone or in combination of two or more thereof.

Each of the main agent and the cuing agent may be used alone or in combination of two or more thereof.

Epoxy resin is obtained by curing (thermosetting) an epoxy resin composition. In preparing the composition A, an epoxy resin composition before axing can be mixed win the redox substance and the carbon material, and aced after mixing.

### (Polycarbonate-Polyorganosiloxane Copolymer)

In one embodiment, the polymeric material contains a polycarbonate-polyorganosiloxane copolymer (hereinafter sometimes abbreviated as “PC-POS” and polyorganosiloxane may also be abbreviate as “POS”).

PC-POS includes, in the main chain, a polycarbonate block containing a repeating unit represented by the general formula (1), and a polyorganosiloxane block containing a siloxane repeating unit represented by the general formula (2).

The hydroxy group terminal fraction of PC-POS is preferably less than 5 mol %.

PC-POS may be used alone or in combination of two or more thereof.

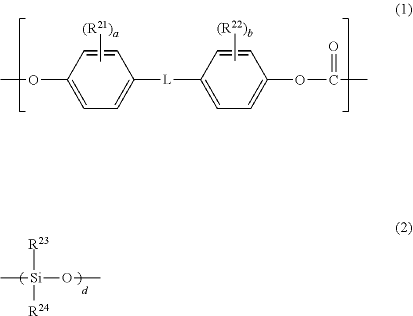

In the formulas, R²¹ and R²² independently represent a halogen atom, an alkyl group including 1 to 6 carbon atoms, or an alkoxy group including 1 to 6 carbon atoms. L represents a single bond, an alkylene group including 1 to 8 carbon atoms, an alkylidene group including 2 to 8 carbon atoms, a cycloalkylene group including 5 to 15 carbon atoms, and cycloalkylidene group including 5 to 15 carbon atoms, a fluorenediyl group, an arylalkylene group including 7 to 15 carbon atoms, an arylalkylidene group including 7 to 15 carbon atoms, —S—, —SO—, —SO₂—, —O—, or —CO—, a and b independently represent an integer of 0 to 4.

R²³ and R²⁴ independently represent a hydrogen atom, a halogen atom, an alkyl group including 1 to 6 carbon atoms, an alkoxy group including 1 to 6 carbon atoms, or an aryl group including 6 to 12 carbon atoms. The average repeating number d represents the total number of siloxane repeating units in the polyorganosiloxane block.

Examples of the halogen atom independently represented by R²¹ and R²² in the generic formula (1) include a fluorine atom, a chlorine atom, a bromine atom, and an iodine atom.

Examples of the alkyl group independently represented by R²¹ and R²² include a methyl group, an ethyl group, an n-propyl group, an isopropyl group, various butyl groups (the “various” means including inclusion of a straight chain and all branched chain forms thereof, and the same applies hereinafter), various pentyl groups, and various hexyl groups. Examples of the alkoxy group independently represented by R²¹ and R²² include those of which the alkyl group moiety is the above alkyl group.

Both R²¹ and R²² are preferably an alkyl group including 1 to 4 carbon atoms or an alkoxy group including 1 to carbon atoms.

Examples of the alkylene group represented by L include, for example, a methylene group, an ethylene group, a trimethylene group, a tetramethylene group, a hexamethylene group, and the like, and an alkylene group including 1 to 5 carbon atoms is preferred. Examples of the alkylidene group represented by L include an ethylidene group, an isopropylidene group, and the like. Ad the cycloalkylene group represented by L, a cycloalkylene group including 5 to 10 carbon atoms is preferred, and examples thereof include a cyclopentanediyl group, a cyclohexanediyl group, a cyclooctanediyl group, and the like. Examples of the cycloalkylidene group represented by L include, for example, a cyclohexylidene group, a 3,5,5-trimethylcyclohexylidene group, a 2-adamantylidene group, and the like, a cycloalkylidene group including 5 to 10 carbon atoms is preferred, and a cycloalkylidene group including 5 to 8 carbon atoms is more preferred. Examples of the aryl moiety of the arylalkylene group represented by L include aryl groups including 6 to 14 ring carbon atoms, such as a phenyl group, a naphthyl group, a biphenyl group, and a anthryl group. Examples of the aryl moiety of the arylalkylidene group represented by L include aryl groups including 6 to 14 ring carbon atoms, such as a phenyl group, a naphthyl group, a biphenyl group, and an anthryl group.

a and b independently represent an integer of 0 to 4, are preferably 0 to 2, and more preferably 0 or 1.

Examples of the halogen atom independently represented by R²³ and R²⁴ in the generic formula (2) include a fluorine atom, a chlorine atom, a bromine atom, and an iodine atom. Examples of the alkyl group and the alkoxy group independently represented by R²³ and R²⁴ include the same as in R²¹ and R²², respectively. Examples of the aryl group independently represented by R²³ and R²⁴ include a phenyl group, a naphthyl group, and the like.

R²³ and R²⁴ are independently preferably a hydrogen atom, an alkyl group including 1 to 6 carbon atoms, an alkoxy group including 1 to 6 carbon alms, or an aryl group including 6 to 12 carbon slams, and R²³ and R²⁴ are more preferably a methyl group.

d in the general formula (2) is an average repeating number, and represents the total number of siloxane repeating units in the polyorganosiloxane block.

In one embodiment, d is preferably from 20 to 500, and more preferably from 50 to 500. When d is 20 or more, excellent impact resistance can be obtained. When d is 500 or less, handing property at the time of producing PC-POS is excellent.

The number of repeating units d can be calculated by ¹H-NMR.

In addition, in one embodiment, the ported of the polyorganosiloxane block (2) in PC-POS is usually 1.0 to 50% by mass, preferably 2.0 to 40% by mass, and more preferably 3.0 to 30% by mass. When the content of the polyorganosiloxane block is 1.0% by mass or more, not only excellent impact resistance characteristics can be obtained but also a large recovery of impact resistance characteristics can be achieved. When the content of the polyorganosiloxane block is 50% by mass or less, handing property at the time of producing PC-POS is excellent.

Furthermore, the viscosity-average molecular weight (Mv) of PC-POS is usually from 10,000 to 30,000, preferably from 12,000 to 28,000, and more preferably from 15,000 to 25,000. When the viscosity-average molecular weight of PC-POS is within this range, the fluidly and the impact resistance are easily balanced.

The viscosity-average molecular weight (Mv) is a value obtained by measuring the limiting viscosity [η] of the methylene chloride solution at 20° C. using an Ubbelohde-type viscosity tube and calculating from Schnell formula ([η]=1.23×10⁶×Mv^{0.83}).

The structure of the polyorganosiloxane block containing the repeating unit represented by the general formula (2), is preferably one represented by the following general formula (2′).

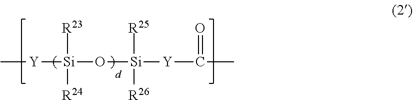

In the formula (2′), R²³ to R²⁶ independently represents a hydrogen atom, a halogen atom, an alkyl group including 1 to 6 carbon atoms, an alkoxy group including 1 to 6 carbon atoms, or an aryl group including 6 to 12 carbon atoms. Y's independently represent a single bond, —C(═O)—, or a divalent organic residue containing an aliphatic group or an aromatic group, d represents the average repeating number.

R²³ to R²⁶ are independently a hydrogen atom, an alkyl group including 1 to 6 carbon atoms, an alkoxy group including 1 to 6 carbon atoms, or an aryl group noticing 6 to 12 carbon atoms. Y is preferably a residue derived from a phenol-based compound having an alkyl group, and more preferably an organic residue derived from allylphenol or an organic residue derived from eugenol.

The structure of the polyorganosiloxane block containing the repeating unit represented by the general formula (2) is also preferably a structure represented by the following formula (2″).

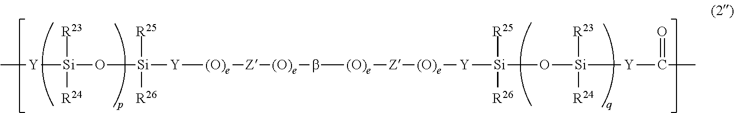

In the formula (2″), R²³ to R²⁶ and Y are the same as those it the formula (2′), and preferred ones are also the same. The sun of p and q is d, and represents the average repealing number described above, p and q are preferably d/2, respectively.

e's independently represent 0 or 1.

Z's independently represent a single bond, —R²⁷O—, —R²⁷COO—, —R²⁷NH—, —COO— or —S—, and R²⁷ represents a straight chain, branched chain, or cyclic alkylene group, or an aryl-substituted alkylene group, arylene group, or diarylene group which may have an alkoxy group on an aromatic ring. Speck examples of R²⁷ will be described later.

Further, β represents a divalent group derived thorn a diisocyanate compound or a divalent group derived from a dicarboxylic acid. Specific examples of the divalent group derived from a diisocyanate compound and the divalent group derived from a dicarboxylic acid will be described later.

The method for producing PC-POS is not particularly limited, and PC-POS can be easily produced by referring to a known method of producing PC-POS, for example, the method described in JP 2010-241943 A1 and the like.

Specifically, PC-POS can be produced by dissolving a polycarbonate oligomer produced in advance and a polyorganosiloxane having a reactive group on the terminal (a polyorganosiloxane represented by any of the following general formulas (4) and (5) or the like) in a water-insoluble organic solvent (methylene chloride or the like), adding to the solution an aqueous alkaline compound solution (such as an aqueous solution of sodium hydroxide) of a divalent phenol represented by the following general formula (3) (such as bisphenol A), and subjecting the mixture to interfacial polycondensation in the presence of a molecular weight regulator (a polymerization terminator) (a monovalent phenol such as p-t-butylphenol) using a tertiary amine (such as triethylamine) or a quaternary ammonium salt (such as trimethylbenzylammonium chloride) as a polymerization catalyst. Incidentally, by varying the amount of the polyorganosiloxane to be used, or the like, the content ratio of the polyorganosiloxane block containing the siloxane repeating unit represented by the general formula (2) in PC-POS component can be adjusted.

After the above interfacial polycondensation reaction, the mixture is left to stand, as needed, and separated into an aqueous phase and a water-insoluble organic solvent phase [separation step], and the water-insoluble organic [washing step], and the obtained organic phase is concentrated [concentration step], pulverized [pulverization step], and dried [drying step], whereby PC-POS can be obtained.

Further, PC-POS can also be produced by copolymerizing divalent phenol represented by the flowing general formula (3), polyorganosiloxane represented by the following general formula (4), and either of phosgene, carbonic ester or chloroformate.

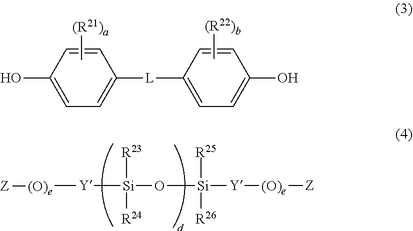

Here, in the general formula (3), R²¹ and R²², L, a, and b are the same as those in the general formula (1). In the general formula (4), R²³ to R²⁶ are the same as those in the general formula (2′), and d is the same as that in the general formula (2). Furrier Y's the same as Y in the general formula (2′).

e's independently represent 0 or 1, Z's independently represent a halogen atom, —R²⁷OH, —R²⁷COOH, —R²⁷NH₂, —R²⁷NHR²⁸, —COOH or —SH, and R²⁷'s independently represent a straight chain, branched chain, or cyclic arylene group, or an aryl-substituted alkylene group, arylene group, or diarylene group which may have an alkyoxy group on an aromatic ring, and R²⁶ represents an alkyl group, an alkenyl group, an aryl group, an aralkyl group, or an alkoxy

The diarylene group is a group in which two arylene groups are directly connected to each other or connected via a divalent organic group, and specifically, a group having a structure represented by —Ar¹—W—Ar²—. Here, Ar¹ and Ar² represent arylene groups, and W represents a singe bond or a divalent organic group. Specific examples and preferred examples of W are the same as L in the general formula (1).

Examples of the straight chain or branched chain alkylene group represented by R²⁷ include an alkylene group including 1 to 8 carbon atoms, and preferrably including 1 to 5 carbon atoms, and examples of the cycle alkylene group include a cycloalkylene group including 5 to 15 carbon atoms, and preferably including 5 to 10 carbon atoms. Examples of the alkylene moiety of the aryl-substituted alkylene group represented by R²⁷ include an alkylene group including 1 to 8 carbon atoms, preferably including 1 to 5 carbon atoms. Examples of the aryl moiety of the aryl-substituted alkylene group represented by R²⁷ include an aryl group including 6 to 14 ring carbon atoms, such as a phenyl group, a naphthyl group, a biphenyl group, and an anthryl group. Examples of the arylene group represented by R²⁷, Ar¹, and Ar² include an arylene group including 6 to 14 ring carbon atoms, such as a phenylene group, a naphthylene group, a biphenyldiyl group, and an anthrylene group.

Preferably, Y′ represents a singe bond, —C(═O)—, or a divalent organic residue which contains an aliphatic group or an aromatic group, and which bonds with Si and O, or Si and Z. R²³ to R²⁶ are independently a hydrogen atom, an alkyl group including 1 to 6 carbon atoms, an alkoxy group including 1 to 6 carbon atoms, or an aryl group including 6 to 12 carbon atoms, d is the same as above, and m represents 0 or 1.

Z is preferably —R²⁷OH, —R²⁷COOH, —R²⁷NH₂, —COOH, or —SH. R²⁷ is as defined above, and the preferred one is also the same as above.

R²⁶ is preferably an alkyl group, an alkenyl group, an aryl group, or an aralkyl group.

The divalent phenol represented by the general formula (3) which is a raw material of PC-POS is not particularly limited, and 2,2-bis(4-hydroxyphenyl)propane [common name: bisphenol A] is suitable. When bisphenol A is used as the divalent phenol, PC-POS in which L is an isopropylidene group and a=b=0 in the general formula (1) is obtained.

Examples of the divalent phenol other than bisphenol A include, for example, bis(hydroxyaryl)alkanes such as bis(4-hydroxyphenyl)methane, 1,1-bis(4-hydroxyphenyl)ethane, 2,2-bis(4-hydroxyphenyl)butane, 2,2-bis(4-hydroxyphenyl)octane, bis(4-hydroxyphenyl)phenylmethane, bis(4-hydroxyphenyl)diphenylmethane, 2,2-bis(4-3-methylphenyl)propane, bis(4-hydroxyphenyl)naphthylmethane, 1,1-bis(4-hydroxy-3-t-butylphenyl)propane, 2,2-bis(4-hydroxy-3-bromophenyl)propane, 2,2-bis(4-hydroxy-3,5-dimethylphenyl)propane, 2,2-bis(4-hydroxy-3-chlorophenyl)propane, 2,2-bis-(4-hydroxy-3,5-dichlorophenyl)propane, and 2,2-bis(4-hydroxy-3,5-dibromophenyl)propane, bis(hydroxyaryl)cycloalkanes such as 1,1-bis(4-hydroxyphenyl)cyclopentane, 1,1-bis(4-hydroxyphenyl)cyclohexane, 1,1-bis(4-hydroxyphenyl)-3,5,5-trimethylcyclohexane, 2,2-bis(4-hydroxyphenyl)norbornane, and 1,1-bis(4-hydroxyphenyl)cyclodecane, dihydroxyaryl ethers such as 4,4′-dihydroxydiphenyl ether, and 4,4′-dihydroxy-3,3′-dimethylphenyl ether; dihydroxy diaryl sulfides such as 4,4′-dihydroxydiphenyl sulfide, and 4,4′-dihydroxy-3,3′-dimethyldiphenyl sulfide; dihydroxydiaryl sulfoxides such as 4,4′-dihydroxydiphenyl sulfoxide, and 4,4′-dihydroxy-3,3′-dimethyldiphenyl sulfoxide; dihydroxydiaryl sulfones such as 4,4′-dihydroxydiphenyl sulfone, and 4,4′-dihydroxy-3,3′-dimethyldiphenyl sulfone; dihydroxydiphenyls such as 4,4′-dihydroxydiphenyl; dihydroxydiarylfulorenes such as 9,9-bis(4-hydroxyphenyl)fluorene, and 9,9-bis(4-hydroxy-3-methylphenyl)fluorene; dihydroxydiaryladamanthanes such as 1,3-bis(4-hydroxyphenyl)adamantane, 2,2-bis(4-hydroxyphenyl)adamantane, and 1,3-bis(4-hydroxyphenyl)-5,7-dimethyladamantane; 4,4′-[1,3-phenylenebis(1-methylethylidene)]bisphenol, 10,10-bis(4-hydroxyphenyl)-9-anthrone, 1,5-bis(4-hyrdoxyphenylthio)-2,3-dioxapentaene, and the like.

These divalent phenols may be used alone or two or more thereof as a mixture.

The polyorganosiloxane represented by the general formula (4) can be easily produced by subjecting a phenolic compound having an olefinic unsaturated carbon-carbon bond (preferably, vinylphenol, allylphenol, eugenol, isopropenylphenol, or the like) to a hydrosilylation reaction at the terminal of a polyorganosiloxane chain having a predetermined degree of polymerization (d: repeating number). More preferably, the phenolic compound is allylphenol or eugenol.

The polyorganosiloxane represented by the general formula (4) is preferably those in which R²³ to R²⁶ are methyl groups.

Examples of the polyorganosiloxane represented by the general formula (4) include, for example, compounds represented by each of the following general formulas (4-1) to (4-10).

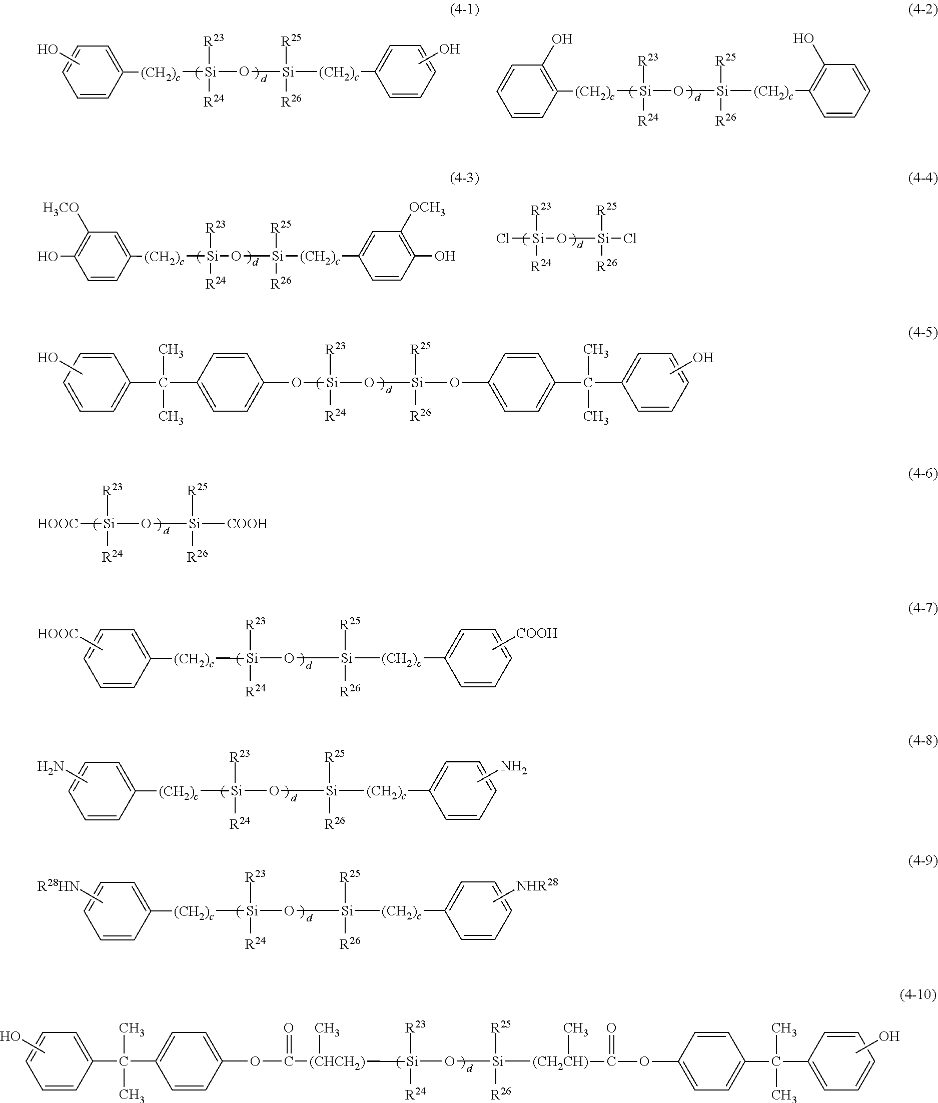

In the formulas (4-1) to (4-10) R²³ to R²⁶, d, and R²⁸ are as defined above, and preferable ones are also the same, c's represent positive integers, and are usually independently an integer of 1 to 6.

Among these, from the viewpoint of ease of polymerization, a phenol-modified polyorganosiloxane represented by the general formula (4-1) is preferred. Alternatively, from the viewpoint of ease of availability, α, ω-bis[3-(o-hydroxyphenyl)propyl]polydimethylsiloxane which is a kind of the compound represented by the general formula (4-2), and α,ω-bis[3-(4-hydroxy-2-methoxyphenyl)propyl]polydimethylsiloxane which is a kind of the compound represented by the general formula (4-3) are preferred.

The phenol-modified polyorganosiloxane can be produced by a known method. Examples of the method of production include the following methods.

First, cyclotrisiloxane and disiloxane are reacted in the presence of an acidic catalyst to synthesize α,ω-dihydrogenorganopolysiloxane. At this time, α,ω-dihydrogenpolyorganosiloxane having a desired average repeating number can be synthesized by varying the charge ratio of cyclotrisiloxane and disiloxane. Then, a phenol compound having an unsaturated aliphatic hydrocarbon group such as allylphenol or eugenol and this α,ω-dihydrogenpolyorganosiloxane are subjected to an addition reaction in the presence of a catalyst for the hydrosilylation reaction, whereby a phenol-modified polyorganosiloxane having a desired average repeating number can be obtained.

In this step, since a cyclic polyorganosiloxane having a low molecular weight and an excessive amount of the phenol compound remain as impurities, it is preferable to carry out heating under reduced pressure to distil off these low molecular weight compounds.

Further, PC-POS may be produced by copolymerizing the divalent phenol represented by the general formula (3), a polyorganosiloxane represented by the following general formula (5), and either of phosgene, carbonic add ester or chloroformate. The polyorganosiloxane represented by the general formula (5) is a reaction product of the polyorganosiloxane represented by the general formula (4) and a diisocyanate compound or a dicarboxylic acid.

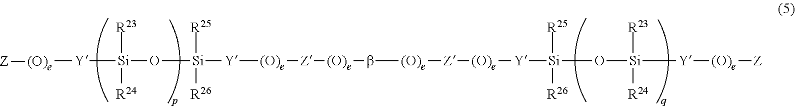

In the formula (5), R²³ to R²⁶, e, p, q, Y′, Z, and Z′ are as defined above, and preferable ones are also the same. Here, p and q in the general formula (5) preferably equal to each other (p=q), that is, p=d/2 and q=d/2 can be mentioned as preferred.

Further, β represents a divalent group derived from a diisocyanate compound or a divalent group derived from a dicarboxylic acid, and examples thereof include divalent groups represented by each of the following general formulas (6-1) to (6-5).

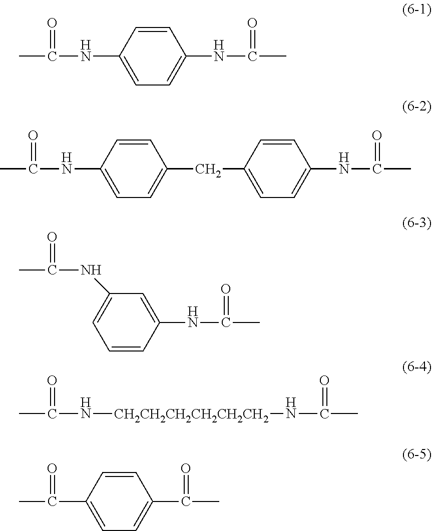

### (Syndiotactic Polystyrene)

In one embodiment, the polymeric material contains syndiotactic polystyrene.

Syndiotactic polystyrene is a crystalline polystyrene having a syndiotactic structure. “Syndiotactic” means a high proportion of which phenyl rings in adjacent styrene units are alternately arranged with respect to a plane formed by the main chain of the polymer block (hereinafter referred to as syndiotacticity). Tacticity can be quantitatively identified by nuclear magnetic resonance with isotopic carbons (13C-NMR). By 13C-NMR method, it is possible to quantify the abundance of a plurality of consecutive constituent units, for example, two consecutive monomer units as a dyad, three consecutive monomer units as a triad, and five consecutive monomer units as a pentad.

In one embodiment, syndiotactic polystyrene means polystyrene, poly(hydrocarbon-substituted styrene), poly(halogenated styrene), poly(halogenated alkylstyrene), poly(alkoxystyrene), poly(vinylbenzoic ester), hydrogenated usually 75 mol % or more, and preferably 85 mol % or more in racemic diads (r), or usually 30 mol % or more, and preferably 50 mol % or more in racemic pandads (rrrr).

Examples of the poly(hydrocarbon-substituted styrene) include poly(methylstyrene), poly(ethylstyrene), poly(isopropylstyrene), poly(tert-butylstyrene), poly(phenyl)styrene, poly(vinylnaphthalene, poly(vinylstyrene), and the like. Examples of the poly(halogenated styrene) include poly(chlorostyrene), poly(bromostyrene), poly(fluorostyrene), and the like. Examples of the poly(halogenated alkylstyrene) include poly(chloromethylstyrene) and the like. Examples of the poly(alkoxystyrene) include poly(methoxystyrene), poly(ethoxystyrenee), and the like.

Examples of the comonomer component of the copolymer containing the above constituent unit include olefin monomers such as ethylene, propylene, butane, hexane, and octene; there diene monomers such as butadiene and isoprene; and polar vinyl monomers such as cyclic olefin monomers, cyclic diene monomers, methyl methacrylate, maleic anhydride, and acrylonitrile; and the like, in addition to the monomers of the above-mentioned styrene-based polymer.

Particularly preferred styrene-based polymers among the above-mentioned ones include polystyrene poly(p-methylstyrene), poly(m-methylstyrene), poly(p-tert-butylstyrene), poly(p-chlorostyrene), poly(m-chlorostyrene), poly(m-chlorostyrene), poly(p-fluorostyrene), and the like. More preferable examples thereof include a copolymer of styrene and p-methylstyrene, a copolymer of styrene and p-tert-butylstyrene, a copolymer of styrene and divinylbenzene, and the like.

In one embodiment, syndiotactic polystyrene preferably has a weight-average molecular weight of 1×10⁴ or more and 1×10⁶ or less, and more preferably 50,000 or more and 500,000 or less, in view of the fluidity of the polymeric materials at the time of molding and the strength of the molded body obtained. When the weight-average molecular weight is 1×10⁴ or more, a molded body having adequate strength can be obtained. On the other hand, when the weight-average molecular weight is 1×10⁶ or less, there is no problem with the fluidity of the polymer material at the time of molting.

In this specification, the weight-average molecular weight of a syndiotactic polystyrene is a value obtained by measuring a gel permeation chromotography (gel permeation chromatography, abbreviation “GPC”) measurement method using a GPC apparatus manufactured by Tosoh Corporation (HLC 8321 GPC/HT) and a GPC column manufactured by Tosoh Corporation (GMHHR-H(S)HT) use 1,2,4-trichlorobenzene as an eluent at 145° C., and converting the value using standard curve of standard polystyrene. The weight-average molecular weight sometimes simply abbreviated as “molecular weight.”

The syndiotactic polystyrene is obtained, for example, by polymerizing a styrene-based monomer using a metallocene catalyst.

The MFR value of the syndiotactic polystyrene is preferably 10 to 50 g/10 min. Here, the MFR value is a valve measured at 2.16 kg at 300° C. according to the method of JIS K7210 (2014).

### (Polypropylene)

In one embodiment, the polymeric material contains polypropylene.

Polypropylene may be a propylene homopolymer or a copolymer. When polypropylene is a copolymer, the copolymerization ratio of the propylene unit is more then 50 mol %, preferably 60 mol % or more, more preferably 70 mol % or more, still more preferably 90 mol % or more, and still more preferably 95 mol % or more. The comonomer may be one or more selected from the group consisting of ethylene and α-olefin including 4 to 30 carbon atoms. Specific examples of the monomer for copolymerization include ethylene, 1-buten, 1-pentane, 1-hexen, 1-octene, 1-decenoic, and the like. When polypropylene is a copolymer, it is preferable that the polypropylene contain one or more constituent units selected from the group consisting of ethylene and α-olefins including 4 to 30 carbon atoms in an amount of more than 0 mol % and 20 mol % or less.

It is preferable that the polypropylene satisfy the following condition (1).

(1) The melting point (Tm-D), which is defined as the peak top observed on the highest-temperature side of the melting endothermic curve obtained by holding the sample at −10° C. for 5 minutes under a nitrogen atmosphere using a differential scanning calorimeter (DSC) and then raising the temperature at 10° C./minute, is not observed or 0° C. or higher and 165° C. or lower.

Note that the melting point can be controlled by appropriately adjusting the monomer concentration and the reaction pressure.

The weight-average molecular weigh (Mw) of polypropylene is preferably 30,000 or more, more preferably 50,000 or more, and all more preferably 70,000 or more, and is preferably 200,000 or less, mare preferably 180,000 or less, and still more preferably 150,000 or less.

The molecular weight distribution (Mw/Mn) of polypropylene is preferably 3.0 or smaller, more preferably 2.8 or smaller, even more preferably 2.6 or smaller, and still more preferably 2.5 or smaller, and is preferably 1.5 or larger, more preferably 1.6 or larger, even more preferably 1.7 or larger, and still more preferably 1.8 or larger.

The weight-average molecular weight (Mw) and molecular weight distribution (Mw/Mn) of polypropylene are determined by gel permeation chromatography (GPC) measurement. The weight average molecular weight of polypropylene is a polystyrene-equivalent weight average molecular weight measured by gel permeation chromatography (GPC) using the following equipment and conditions, and the molecular weight distribution of polypropylene is a value calculated from the number-average molecular weight (Mn) measured in the same manner and the weight-average molecular weight described above.

### <GPC Measurement Apparatus>

Column: “TOSO GMHHR-H(S)HT” manufactured by Tosoh Corporation

Detector: RI-Detector for liquid chromatogram “WATERS 150C” manufactured by Waters Corporation

### <Measurement Condition>

Solvent: 1,2,4-trichlorobenzene

Measurement temperature: 145° C.

Flow rale: 1.0 mL/min

Sample concentration: 22 mg/mL

Injection: amount 160 μL

Calibration curve: Universal Calibration

Analysis program: HT-GPC (Ver. 1.0)

The melt flow rate (MFR) of polypropylene may be, for example, 0.1 g/10 minutes or larger, 0.5 g/10 minutes or larger, 1.0 g/10 minutes or larger, 10 g/10 minutes or larger, 30 g/10 minutes a larger, or 60 g/10 minutes or larger, and may be 5000 g/10 minutes or smaller, 3000 g/10 minutes or smaller, 1500 g/10 minutes or smaller, 1300 g/10 minutes or smaller, 1000 g/10 minutes or smaller, 8000 g/10 minutes or smaller, 500 g/10 minutes or smaller, 300 g/10 minutes or smaller, 200 g/10 minutes a smaller, a 100 g/10 minutes a smaller. The MFR of polypropylene is measured in accordance with ISO 1133:1997, under conditions of temperature of 230° C. and a load of 21.18 N.

Further, the limiting viscosity [η] of polypropylene may be, to example, 0.01 dL/g or larger and 4 dL/g a smaller.

The above-mentioned limiting viscosity [η] is obtained by measuring the reduce viscosity (η_{SP}/c) in tetralin at 135° C. with a Ubbelohde-type viscometer and calculating by means of the following formula (formula of Huggins),

η_{SP}/c=[η]+K[η]²c

η_{SP}/c: reduced viscosity

[η] (dL/g): limiting viscosity

c (g/dL): polymer viscosity

K=0.35 (Huggins constant)

As polypropylene, a commercially available product can be used. Specific example thereof include “Prime Polypro” manufactured by Prime Polymer Co., Ltd., “NOVATEC PP, WINTEC” manufactured by Japan Polypropylene Corporation, “Sumitomo Noblen” manufactured by Sumitomo Chemical Company, Limited, and “S400,” “S600.” and “S901” of “L-MODU” (registered trademark) manufactured by Idemitsu Kosan Co., Ltd. Examples of the commercially available product of amorphous poly α-olefin include “APAO” manufactured by REXtac, LLC, “Vestoplast” manufactured by Evonik Industries AG, and the like (all are trade names). Examples of the commerically available product of propylene-based elastomer include “TAFMER XM,” “TAFMER PN,” and “TAFMER SN” manufactured by Mitsui Chemicals, Inc.; “Taffhren” manufactured by Sumitomo Chemical Company; “PRIME TPO” manufactured by Prime Polymer Co., Ltd.; “Versify” manufactured by The Dux Chemical Company; “Vistamaxx” and “Linxar” manufactured by Exxon Mobil Corporation; “Licocene” manufactured by Clariant AG; and “Adflex” manufactured by LyondellBasell Industries N.V. (all are trade names).

### (Solvent)

In one embodiment, the composition A further contains a solvent. The solvent may be used, for example, for the purpose of uniformly mixing the components contained in the composition A, or for the purposed forming a coating material to be described later. In otter embodiments, the composition A does not contain a solvent.

The solvent is not particularly limited, and examples thereof include a compound having a hydroxy group and a butoxy group. The compound having a hydroxy group and a butoxy group is preferably one or more selected from the group consisting of propylene glycol mono-n-butyl ether, propylene glycol mono-tert-butyl ether, propylene, glycol monoisobutyl ether, ethylene mono-n-butyl ether, ethylene glycol mono-tert-butyl ether, and ethylene glycol monoisobutyl ether.

### (Other Components)

In one embodiment, the composition A contains other components in addition to the carbon material, the redox substance, the polymeric material, and the solvent describe above, within a range not impairing the effect of the invention. Examples of the other components include known additives such as a colored pigment, a plasticizer, a pigment dispersant, an emulsifier, a thickener, an anti-scattering agent, and a leveling material.

### (Blending Ratio)

In the following description, the amount of the redox substance is the amount of complex if the redox substance is a complex doped by a dopant.

The blending ratio of the carbon material and the redox substance is not particularly limited, and for example, the ratio of the redox substance relative to 100 parts by mass of the carbon material may be 0.0001 parts by mass or more, 0.001 parts by mass or more, 0.002 parts by mass or more, 0.005 parts by mass or more, or 0.01 parts by mass or more, and may be 100 parts by mass or less, 70 parts by mass or less, 50 parts by mass or less, 30 parts by mass or less, or 20 parts by mass or less,

The blending ratio of the carbon material and the polymeric material is not particularly limited, and for example, the ratio of the polymeric material relative to 100 parts by mass of the carbon material may be 0 part by mass or more, 5 parts by mass or more, 10 parts by mass or more, 50 parts by mass or more, or 100 parts by mass or more, and may be 800 parts by mass or less, 600 pars by mass or less, 500 parts by mass or less, 400 parts by mass or less, or 300 parts by mass or less,

When the composition A is used as a material of an injection molded body, a ratio of the polymeric material relative to 100 parts by mass of the carbon material may be, for example, 50 parts by mass or more, and may be 800 parts by mass or less or 500 parts by mass or less,

When the composition A is obtained by impregnating a polymeric material into a woven fabric, a nonwoven fabric, or a unidirectional material of carbon fibers, the ratio of the polymeric material relative to 100 parts by mass of the carbon material may be, for example, 10 parts by mass or more, and may be 100 parts by mass or less or 25 parts by mass or less,

In one embodiment, when the composition A from which the solvent is excluded is set to be 100 mass %, 50 mass % or more, 60 mass % or more, 70 mass % or more, 80 mass % or more, 90 mass % or more, 95 mass % or more, 97 mass % or more, 99 mass % or more, 99.5 mass % or more, or 100 mass % of the composition A is composed of:

the carbon material and the redox substance;

the carbon material, the redox substance, and the polymeric material;

the carbon material, the redox substance, and one or more selected from the group consisting of a colored pigment, a plasticizer, a pigment dispersant, an emulsifier, a thickener, an anti-scattering agent, and a leveling material; or

the carbon material, the redone substance, the polymeric material, and one or more selected from the group consisting of a colored pigment, a plasticizer, a pigment dispersant, an emulsifier, a thickener, an anti-scattering agent, and a leveling material. The composition A composed thereof may contain unavoidable impurities.

The content of the solvent in the composition A is not particularly limited, and when the composition A from which the solvent is excluded (solid content) is set to be 100 parts by mass, the content of the solvent may be, for example, 0 part by mass or more, 5 parts by mass or more, 10 parts by mass or more, 20 parts by mass or more, or 50 parts by mass or more, and may be 5000 parts by mass or less, 2000 parts by mass or less, 1000 parts by mass or less, 700 parts by mass or less, or 500 parts by mass or less,

In one embodiment, when the composition A from which the solvent is excluded is set to be 100 parts by mass, the content of the redox substance may be, for example, 20% by mass or less, 18% by mass or less, 15% by mass or less, 13% by mass or less, 10% by mass or less, 8% by mass or less, 5% by mass or less, 4% by mass or less, or 3.5% by mass or less, and may be 0.01% by mass or more, 0.05% by mass or more, 0.1% by mass or more, or 0.12% by mass or more.

In one embodiment, the content of the redox substance may be further less, and when the composition A from which the solvent is extruded is set to be 100 parts by mass, the content of the redox substance may be, for example, 1.5% by mass or less, 1.3% by mass or less, 1.0% by mass or less, 0.8% by mass or less, or 0.5% by mass or less, and may be 0.05% by mass or more, 0.1% by mass or more, or 0.5% by mass or more.

For exhibiting the effect of the invention, it is considered important that an oxide film is lowed by a redox substance, and conductivity and the like derived from the redox substance are not necessarily required. Therefore, even when the content of the redox substance is little, the effect of the invention is favorably exhibited. Further, since the content of the other components (carbon material or polymeric material) can be relatively increased by decreasing the content of the redox substance, the strength of the composition A can be increased and also the effect of reinforcing other members combined with the composition A can be increased. Further, since the content of the polymeric material can be relatively increased, the function due to the polymeric material (adhesiveness or the like) can be suitably exhibited.

In one embodiment, since the redox substance has an excellent solubility, the redox substance can be more uniformly dispersed into the other components contained in the composition A, and the effect of the inverters is well exhibited. Examples of the redox substance having excellent solubility include a complex of a subsided or unsubstituted polyaniline and a compound represented by the formula (II) described above (dopant).

In one embodiment, when the composition A contains a polymeric material, the polymeric material is mixed with the redox substance dissolved in a solvent, in the process of preparing the composition A. By this procedure, the redox substance can be more uniformity dispersed in the polymeric material or in the composition A, and the effect of the invention is well exhibited.

### (Method for Producing Composition)

The method for producing the composition A described above is not particularly limited. As one example, a method of mixing a carbon material and a redox substance together with one or more arbitrary components selected from the group consisting of a polymeric material, a solvent, and other components can be used. In this case, the form of the composition may be, for example, a molded body such as a pellet or the like, or may be in the form of a liquid matter (e.g., paint) or the like.

As another example for producing the composition A, when the carbon material is one or more selected from the group consisting of a woven fabric, a nonwoven fabric, and a unidirectional material (when the carbon material is a cloth-like body), a method of applying a redox substance to a cloth-like body together with one or more arbitrary components selected from the group consisting of a polymeric material, a solvent, and other components (coating method) can be used. Alternatively, a method of immersing a cloth-like body in a liquid matter containing a redox substance, and one or more arbitrary components selected from the group consisting of a polymeric material, a solvent, and other components can be used. The composition thus obtained may be in the form of, for example, CFRP (carbon fiber-reinforced thermosetting resin), CFRTP (carbon fiber-reinforced thermoplastic resin), pultrusion material, and the like.

### 2. Molded Body

The molded body according to one aspect of the invention contains the composition A. The molded body can be produced by molding the composition A.

The form of the molded body is not particularly limited, and examples thereof include, for example, a pellet a ribbon, a plate, a rod, and the like. The pellet may be, for example, a long fiber pellet produced by a pultrusion method, or a short-fiber-reinforced pellet produced using a biaxial kneader or the like. The pellet can be used as an injection molding material or an extrusion molding material.

The molded body may constitute a second portion of the composite molded body, which will be described later. In addition, when the molded body is in a form such as a pellet or the like, the second portion of the composite molded body may be brined through another molding process. The another molding process may be performed in a state in which the molded body is melted by heating, or may be performed in a state in which the molded body is dissolved or dispersed in a solvent (e.g., the solvent described for the composition A). The solvent can be removed by drying.

### 3. Antirust Paint

The antirust paint according to one aspect of the invention contains the composition A. Here, the composition A may contain the solvent described for the composition A.

For the antirust paint, from the viewpoint of suitably preventing galvanic corrosion, it is preferable to empty a redox substance having an excellent solubility into a solvent. From such viewpoint, it is preferable to use the above-described polyaniline complex as the rectos substance.

The antirust paint can be applied to any surface on which antirust properly is required. This surface may contain a metal exemplified for a first portion in a composite molded body described later. The antirust paint is applied on the surface, followed by distillation of the solvent, thereby an antirust treatment on the surface can be performed.

### 4. Composite Molded Body

The composite molded body according to one aspect of the invention contains a first portion and a second portion, wherein the first portion contains a metal, the second portion contains a composition A, and the first portion and the second portion are in contact with each other at least in part. According to this aspect, although the first portion and the second portion are in contact with each other, galvanic corrosion can be suppressed.

The first portion preferably contains a metal or alloy containing one or more selected from the group consisting of iron, aluminum, zinc, magnesium, and copper. As iron, those containing additives such as, for example, Si, and the like can also be used. The first portion containing zinc may be, for example, a galvanized member, and a galvanized steel plate can be preferably exemplified.

The form of the first portion is not particularly limited, and may be, for example, a plate-like body (metal plate) or the like. The first portion may also be a fastening means such as, for example, a bolt, a nut or the like. The first portion, which is a fastening means, can be used, for example, to fasten the second portion to an arbitrary third portion. In this case, the third portion may or may not contain a metal.

### 5. Automobile Part

The automobile part according to one aspect of the invention contains the composite molded body described above.

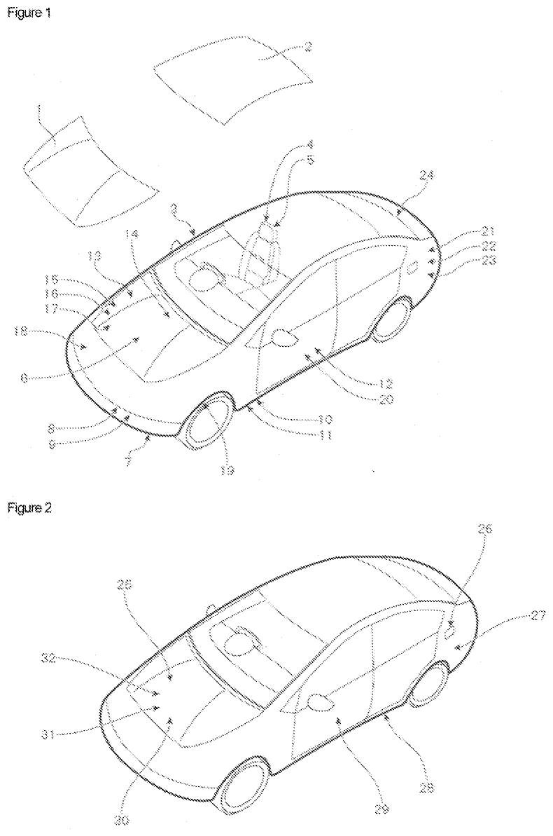

Examples of the automobile parts composed of the composite molded body will be described with reference to FIGS. 1 to 4. Incidentally, in an automobile, the position at which each automobile part is provided is not necessarily limited to the examples shown in FIGS. 1 to 4.

As shown in FIG. 1, the composite molded body may suitably constitute, for example, a hood 1, a roof 2, a door frame pillar 3, a seatback 4, a headrest support 5, an engine component 6, a crash box 7, a front floor tunnel 8, a front floor panel 9, an undercover 10, an undersupport rod 11, an impact beam 12, a lender support 13, a front cowl 14, a front engine cover 15, a front strut lower bar 16, a mission center tunnel 17, a radiator core support 18, a front dash 19, a door inner 20, a rear back panel 21, a rear luggage side panel 22, a rear luggage floor 23, a rear luggage partition 24, and the like.

Further, as shown in FIG. 2, the composite molded body may suitably constitute, for example, a power electronic unit 25, a quick charging plug 26, an in-vehicle charger 27, a lithium-ion battery 28, a battery control unit 29, a power electronic control unit 30, a three-phase synchronous motor 31, a home charging plug 32, and the like.

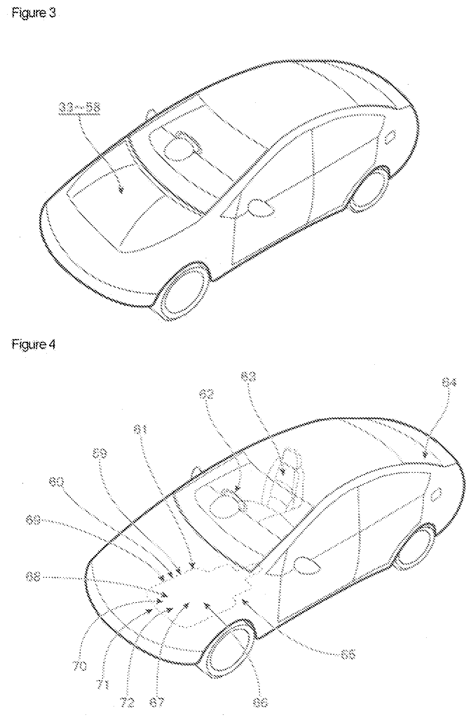

Furtherer, as shown in FIG. 3, the composite molded body may suitably constitute, for example, a solar twilight sensor 33, an alternator 34, an EDU (electronic injector driver unit) 35, an electronic throttle 36, a tumble control valve 37, a throttle opening sensor 38, a radiator fan controller 39, a stick coil 40, an A/C pipe joint 41, a diesel particulate collection filter 42, a headlight reflector 43, a charge air duct 44, a charge air cooling head 45, an intake air temperature sensor 46, a gasoline fuel pressure sensor 47, a cam/crank position sensor 48, a combination valve 48, an engine oil pressure sensor 50, a transmission gear angle sensor 51, a continuously variable transmission oil pressure sensor 52, an ELCM (evaporative leak check module) pump 53, a water pump impeller 54, a steering roll connector 55, an ECU (engine computer unit) connector 56, an ABS (anti-lock brake system) reservoir piston 57, an actuator cover 58, or the like.

Further, as shown in FIG. 4, the composite molded body is also suitably used, for example, as a sealing material for sealing a sensor equipped in an in-vehicle sensor module. Such sensors are not particularly limited and examples thereof include, for example, an atmospheric pressure sensor 59 (e.g., for altitude correction), a boost pressure sensor 60 (e.g., for fuel injection control), an (ICed) atmospheric pressure sensor 61, an acceleration sensor 62 (e.g., for air bag), a gauge pressure sensor 63 (e.g., for sheet condition control), a tank internal pressure sensor 64 (e.g., for fuel tank leak detection), a refrigerant pressure sensor 65 (e.g., for air conditioning control), a coil driver 66 (e.g., for ignition coil control), an EGR (exhaust recirculation) valve sensor 67, an airflow sensor 68 (e.g., for fuel injection control), an intake manifold air pressure (MAP) sensor 69, an oil pan 70, a radiator cap 71, an intake marigold 72, and the take.

Automotive parts composed of the composite molded body are not limited to those exemplified with reference to FIGS. 1 to 4, and are suitably used, for example, for a high voltage (harness) connector, a millimeter-wave radome, an IGBT (insulated gate bipolar transistor) housing, a battery fuse terminal, a radiator grill, a meter hood, an inverter cooling water pump, a battery monitoring unit, a structural component, an intake manifold, a high voltage connector, a motor control ECU (engine computer unit), an inverter, a piping component, a canister purge valve, a power unit, a bus bar, a motor reducer, a canister, and the like.

### 6. Aircraft Part

for the aircraft part according to one aspect of the Invention contains the composite molded body.

The aircraft is not particularly limited and examples thereof includes, for example, manned aircraft, unmanned aircraft, manned spacecraft, unmanned spacecraft, manned rotorcraft, unmanned rotorcraft, an artificial satellite, a rocket, a drone, and the like. The composite molding body may constitute a part for an aircraft, such as a frame, a body, or the like, in these aircrafts.

### 7. Material for Industrial Machinery

The material tar an industrial machinery amazing to one aspect of the invention contains the composite molded body.

The industrial machinery is not particularly limited, and examples thereof include, for example, a robot or the like. The composite molded body may constitute a part for an industrial machinery such as an arm, a gripper, a body, a frame, a reinforcement, or the like, of a robot or the like.

### 8. Other Application

When the composite molded body is used as a member constituting a moving body such as the part for an automobile described above, the part for an aircraft described above, the part for an industrial machinery or the like, the reinforcement effect, weight reduction, and the like by the carbon material become significant. Further, by suppressing galvanic corrosion, the long-lifetime of the part is also attained. However, the application of the composite molded body as not limited to these examples.

The composite molded body is also used to in a two-wheeled vehicle part and a bicycle part, and more specifically, a motorcycle part, a two-wheeled vehicle cowl, and the like.

The composite molded body can also be used for various electric appliances. For example, the composite molded body is also preferable to configure parts for a water heater, specifically a natural refrigerant heat pump water heater known as a so-called “EcoCute (registered trademark)” or the like. Such parts include, for example, a shower part, a pump part, a piping part, and the like, and more specifically, a one-port circulating connection fitting, a relief valve, a mixing valve unit, a heat resistance trap, a pump casing, a complex water valve, a water-inlet fitting, a resin joint, a piping part, a resin pressure reducing valve, an elbow for a water tap, and the like.

The composite molded body is also suitably used for home appliances and electronic appliances, and specific examples thereof include a microwave oven, a telephone, a cellular phone, a refrigerator, an office automation (OA) equipment, a power tool part, an electric tool part, an application for an electrical part, an application for preventing static electricity, a high-frequency electronic part, a high heat-dissipating electronic part, a high-voltage part, an electromagnetic wave shielding part, a telecommunication equipment, an audio-visual equipment, a personal computer, a register, an electric fan, a ventilating fan, a sewing machine, an ink peripheral part, a ribbon cassette, an air-cleaner part, a toilet seat, a hot-wash toilet seat part, a toilet seat part, a toilet cover, a rice cooker part, an optical pickup device, a lighting fixture part, a DVD, a DVD-RAM, a DVD pick-up part, a DVD pick-up substrate, a switch part, a socket, a display, a video camera, a filament, a plug, a high-speed color copier (laser printer), an inverter, an air conditioner, a keyboard, a converter, a television, a facsimile, an optical connector, a semiconductor chip, an LED part, a washer part, a washer/dryer part, a dishwasher part, a dishwasher/dryer part, and the like.

The composite molded body is also suitably used as a building material, and more specifically, an outer wall panel, a back panel, a partition wall panel, a signal light, an emergency light, a wall material, and the like can be mentioned.

The composite molded body is also suitably used for general merchandise, daily necessities, and the like, and more specifically, chopsticks, a boxed lunch box, a tableware container, a food tray, a food packaging material, a water tank, a tank, a toy, sporting goods, a surfboard, a door cap, a door step, a pachinko machine part, a remote control car, a remote control case, a stationery, a musical instrument, a tumbler, a dumbbell, a helmet box product, and the like can be mentioned.

A part or whole of each of the various parts described above may be composed of the composite molded body.

### 9. Method of Producing Composite Molded Body

The method of producing a composite molded body according to one aspect of the invention can be used for producing the composite molded body described above.

The method of producing a composite molded body according to one embodiment contains a step of adjoining the composition A to a first portion containing a metal. IN the process of producing the composite molded body, the composition A may or may not contain a solvent. In the final product of the composite molded body, the solvent is preferably removed by drying or the like. Even when the composition A does not contain a solvent, the composition A can be softened, flowed (melted), or deformed by heating or the like.

In the step of adjoining the composition A, the method of imparting the composition A to the first portion is not particularly limited. In one embodiment, the composition A is imparted to the first portion by one or more selected from the group consisting of a method of applying the composition A to the first portion, a method of immersing the first portion in the composition A, and a method of performing insert-molding using the composition A for the first portion.

In the method of immersing the first portion in the composition A, the whole or a part of the first portion may be immersed in the composition A. After immersion, the composition A may be adjoined only to the surface of the first portion, or the composition A may be impregnated from the surface to the interior of the first portion. When the composition A is impregnated into the interior of the first portion, the component A may be impregnated only to a part of the interior of the first portion (e.g., on the surface portion excluding the center portion) or may be impregnated over the entire interior of the first portion (including the center portion and the surface portion).

In the method of performing insert-molding using the composition A for the first portion, and the insert-molding is a method for obtaining a molded body to which the composition A is adjoined to the first portion by inserting the whole or a part of the first portion into a mold having a predetermined shape and then filling the composition A. A conventionally known method thereof can be adopted. In one embodiment, by applying pressure or the like to the composition A, the composition A is filled into the mold through a hole provided in the mold, and the composite molded body is obtained by adjoining the composition A to the whole or a part of the first portion. As a method of filling the composition A, a method such as injection compression molding can be preferably used in addition to injection molding and compression molding, and a injection molding method is more preferably used.

A method of holding the whole or a part of the first portion in the mold is not particularly limited, and a known method can be adopted, for example, a method of fixing using a pin or the like, or a method of fixing by a vacuum line. The composite molded body obtained by insert molding has a joint portion of the composition A and the whole or a part of the first portion, and the shape thereof is not limited. For example, a shape in which all or a part of the first portion is overlapped with the composition A, a shape in which all or a part of the first portion is wrapped by the composition A, and the like are also included.

### 10. Method of Suppressing Corrosion of Metal Portion

The method of suppressing corrosion de metal portion according to one aspect of the invention contains the step of forming a composition portion containing the composition A to contact with the metal portion at least in part. By the method, corrosion of the metal portion, in particular galvanic corrosion is suppressed. In the embodiment, for the metal portion, the description for the first portion of the composite molded body is incorporated. The metal portion may constitute all or a part of any component.

In the process of forming a composition portion comprising the composition A can be molded such that the composition portion and the metal portion are in contact with each other at least in part. In this step, the composition may or may not contain a solvent. In the same manner as in the method for producing a composite molded body, in this step, the composition can be adjoined to the metal portion by one or more selected from the group consisting of a method of applying the composition to the metal portion, a method of immersing the metal portion in the composition, and a method of performing insert-molding using the composition for the metal portion.

### 11. Sizing Material for Carbon Fibers

As for each configuration according to each of aspects using the sizing material for carton fiber described below, the description of each configuration described above is appropriately incorporated.

A sizing material for carbon fiber according to one embodiment of the invention contains a redox substance. The sizing material for carbon fiber a adjoined to carbon fibers as a binding material for binding carbon fibers together. By the use of the sizing material, the redox substance can be adjoined to the periphery of the carbon fiber. As a result, galvanic corrosion is suitably suppressed when the carbon fibers thus sized is used in order to random the metal part.

For the redox substance, the description set forth for the composition A is incorporated.

In one embodiment, the sizing material for carbon fibers further contains a polymeric material. Also for polymeric materials, the description for the composition described above is incorporated.

Carbon fibers with the sizing material according to one embodiment the invention contains carbon fibers and the sizing material for carbon fibers describe above.

The carbon fibers with the sizing material can maintain a tendency that the string material containing a redox substance is selectively distributed around the carbon fibers even when the carbon fibers are subsequently mixed with a polymeric material to form pellets or the like. This tendency can also be maintained in a molded body obtained by injection molding or extrusion molding using the pellets. As a result, even if the molded body is used in combination with the metal part, galvanic corrosion is suitably suppressed.

The form of the carbon fiber is not particularly limited, and is preferably in one or more forms selected from the group consisting of, for example, a chopped strand, a roving, a woven fabric, a nonwoven fabric, and a unidirectional material.

A polymeric material composition according to one embodiment of the invention contains carbon fibers with a sing material. The composition may contain a polymeric material derived from the carbon fibers with the sizing material or may contain a polymeric material blended separately from the carbon fibers with the sizing material. As the polymeric material, terse described for the composition A can be used.

The composite molded body according to one embodiment of the invention is a composite molded body containing a polymeric material portion and a metal portion, wherein the polymeric material portion contains the above-described polymeric material composition, and the polymeric material portion and the metal portion are in contact with each other at least in part.

A method of producing a composite molded body according to one embodiment of the invention is a method of producing a composite molded body described above, including a step of adjoining the above-described polymeric material composition to a metal portion.

A method of suppressing corrosion of metal portion according to one embodiment of the invention contains a step of forming a polymeric material portion containing of the above-described polymeric material composition such that the composition portion and the metal portion are in contact with each other at least in part.

In the above description, the configurations described fa one embalmed can be appropriately combined with other embodiments,

### EXAMPLES

Hereinafter, examples of the invention will be described, and the invention is not limited by these Examples.

### 1. Reparation of Composition A (Antirust Paint)

### Example 1

In 600 mL, of toluene, 35.0 g of Aerosol OT (sodium di(2-ethylhexyl)sulfosuccinate, purity: 75% or higher, manufactured by Wako Pure Chemise Industries, Ltd.) and 1.47 g of Sorbon T-20 (a nonionic emulsifier having a polyoxyethylene sorbitan fatty acid ester structure, manufactured by Toho Chemical Industry Co., Ltd.) were dissolved toluene to prepare a solution.

The resulting solution was put into a 6 L separable flask placed under a nitrogen steam, and 22.2 g of aniline was added thereto. Then, 1800 mL of 1 mol/L phosphoric add aqueous solution was added thereto, and the solution was cooled to 5° C. The solution had two liquid phases of toluene and water.

Immediately after the temperature of the solution became 5° C., the solution was stirred at 390 rotations per minute. To the solution after stirring, a solution ammonium persulfate, obtained by dissolving 65.7 g of ammonium persulfate in 600 mL of 1 mol/L phosphoric add, was added dropwise over a period of 2 hours using a dropping funnel with stirring. For 18 hours from the stat of the dropwise addition, the solution was stirred while keeping the internal temperature of the solution at 5° C. Then, the solution temperature was increased up to 40° C. and was stifled for an additional 1 hours. After sting, the solution was let to strand to allow the solution separate into two phases. The aqueous phase was separated and the organic phase was collected.

To the obtained organic phase, 1500 mL of toluene was added, and the mature was washed once with 600 mL of 1 mol/L phosphoric add and 3 tines with 600 mL of ion-exchanged water. The insoluble mailer was removed by filtration using a #5C filter paper to obtain a toluene solution of a polyaniline complex.

The obtained toluene solution was transferred to an evaporator, and the volatiles were distilled off under reduced pressure while being warmed in a hot water bath at 60° C., to obtain 43.0 g of powdery polyaniline complex.

The weight-average molecular weight of polyaniline was 60,000. Note that the molecular weight was determined by gel permeation chromatography (GPC) in terms of polystyrene using the following measurement method

### <Measurement Method of Weight-Average Molecular Weight of Polyaniline 22

In a mixed solvent of 1 mL of toluene and 72 μL of isopropanol, 50 mg of a sample to be measured for weight-average molecular weight was dissolved. To the solution, 50 μL of N-methyl-2-pyrrolidone (NMP) containing 0.01 M of LiBr, in which 0.01% by mass of triethylamine was dissolved, was added and the solution was stirred. The weight-average molecular weight and the molecular weight distribution were measured by GPC (gel permeation chromatography) using a solution obtained by removing a solid matter by filtration using a 0.45 μm filter as a measurement solution. Measurements ware carried out using GPC column (two columns of “Shodex KF-806M” manufactured by Shove Denko K.K.) under the measurement conditions of using a NMP containing 0.01 M LiBr as the solvent, the flow rate 0.70 ml/min, the column temperature at 60° C., the injection amount 100 μL, and the UV detection wavelength of 270 nm. In addition, the weight-average molecular weight was determined in polystyrene equivalent from a calibration curve prepared by using standard polystyrenes having 10 levels within a range of molecular weights of 500 to 4,500,000.

1 g of the polyaniline complex obtained as described above was weighted and added to 9 g of propylene glycol monobutyl ether with stirring to obtain a 10% by mass solution of the polyaniline complex.

Subsequently, 10 g of the polyaniline complex solution was added to 90 g of Daiferamine (manufactured by Dainichiseika Color & Chemicals Mfg. Co., Ltd., a γ-butyrolactone solution with 30% by mass of thermosetting polyurethane) as a polymeric material solution, and the mature was stirred at 2000 rpm for 5 minutes using a self-revolving type stirrer (“ARE-250,” manufactured by THINKY CORPORATION) to prepare a solution composition. To the solution composition, carbon fibers (“TR06UB4E,” manufactured by Mitsubishi Chemical Corporation, chopped strands) were added so that the concentration of the carbon fibers became to be 1% by mass, to obtain a composition A (antirust paint).

The composition of the composition A obtained is as forms.

Carbon material (carbon fibers): 1% by mass
Redox substance: 1% by mass
(redox potential of polyaniline complex: 0.5 (V vs. SHE))
Polymeric material: 27% by mass
(redox potential of thermosetting polyurethane: 1.9 (V vs. SHE); note that the redox potential was noisy and unstable during measurement)
Solvent: remaining

Note that the redox potentials of the polyaniline carries and the thermosetting polyurethane were measured by the following method.

### <Method for Measuring Redox Potential>

A substance (compound) to be measured was dispersed a dissolved in an electrolytic solution in which 0.1 mol/L of a supporting electrolyte (here, NaCl) was dissolved, and after 1 minute, by the three-electrode system of a working electrode, a reference electrode, and a counter electrode, the natural potential of the working electrode with respect to the reference electrode was measured. Gold was used as the working electrode. The measurement was carried out at a temperature of 23° C.

### Comparative Example 1

A comparative composition (paint) was obtained in the same manner as in Example 1, except that the addition of the polyaniline couples solution was omitted.

The composition of the obtained comparative composition is as follows.

Carton material (carbon fibers): 1% by mass
Paretic material (thermosetting polyurethane): 30% by mass
Solvent remaining

### 2. Production of Composite Molded Body (Suppression of Corrosion of Metal Portion)

### Example 2

On a SPCC steel plate (metal portion) washed aid degreased with acetone, the composition A (antirust paint) obtained in Example 1 was applied at a film thickness of 63 μm, and the solvent was dried to form a coating film (composition portion) to serve as a test sample of a commode molded body.

The test sample was placed in a constant temperature and humidity chamber (“LH33-12P,” manufactured by Nagano Science Co, Ltd.) conditioned at 60° C. aid 85% RH, and taken out after 36 hours. Next, the coating film was dissolved and peeled off with γ-butyrolactone to observe neon the surface.

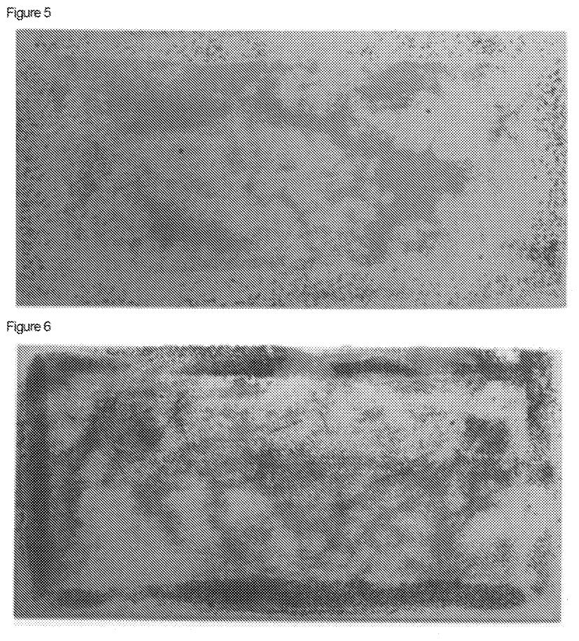

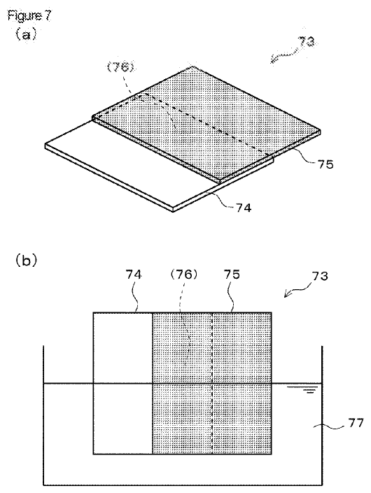

The ratio of area in which rust occurred (rusting ratio) of the observation area of 5 cm×10 cm was 32%. In calculating the rusting ratio, the area where rust was generated was calculated from the shading contrast using the image analysis software “ImageJ.” A photograph of the surface is shown in FIG. 5.

### Comparative Example 2

A test was carried out in the same manner as in Example 2, except that the comparative composition (paint) obtained in Comparative Example 1 was used in place of the composition A (antirust paint) obtained in Example 1. In the observation area of 5 cm×10 cm, the ratio of the area in which rust occurred was 68%. In addition, rust was observed to be concentrated around the carbon fibers. A photograph of the surface is shown in FIG. 6.

### Reference Example 1

A test was carried out in the same manner earn Example 2, accept that a SPCC steel plate (metal portion) washed and degreased with acetone was used as a test sample.

Of the observation area of 5 cm×10 cm, the ratio of the area in which net occurred was 5%.

Comparison between Reference Example 1 and Comparative Example 1 (in which the carbon material was in contact with the metal) reveals that the carbon material causes metal corrosion.

### 3. Evaluation

For the test samples alter the tests in Example 2 and Comparative Example 2, referring to the degree of rust according to ASTM D610, the degrees of rust were classified in accordance with the following evaluation criteria. The results are shown in Table 1.

### [Evaluation Criteria for Degree of Rust]

10: No rust is observed, or rust area is 0.01% or less
9: Rust area is 0.03% or less
8: Slight spot rust is observed, and rust area is 0.1% or less
7: Rust area is 0.3% or less
6: Slight spot rust is observed, and rust area is 0.1% or less
5: Rust area is about 3%
4: Rust area is about 10%
3: Rust area is ⅙ of the total area
2: Rust area is ⅓ of the total area
1: Rust area is nearly half of the total area
0: Rust areas is almost 100%

TABLE 1

| | Degree of rust | Rusting |
|---|---|---|
| | (ASTM D610) | ratio |
| Example 2 | 2 | 32% |
| Comparative | 1 to 0 | 68% |
| Example 2 | | |

### 4. Brine Immersion Test 1

### Example 3

An epoxy resin composition E1 (“GM-6800” manufactured by Genus (two-comment epoxy resin for FRP) was prepared as a polymeric material (raw material). The epoxy resin composition E1 contains a main material (epoxy compound) and a cuing agent (amine-based) in a mass ratio of the main material:the curing agent=3:1, and further contains 10% by mass of a advent based on the total amount of the epoxy resin composition E1.

Then, to 95 parts by mass of the epoxy resin composition E1, 5 parts by mass of propylene glycol monobutyl ether solution of the polyaniline complex obtained in Example 1 (polyaniline complex concentration of 20% by weight) was added to obtain a mixture (liquid matter).

Note that, although the redox potential of the epoxy resin obtained by curing (thermosetting) the epoxy resin composition E1 was measured by the same measurement method as in Example 1, it was confirmed that the result was noisy and unstable, and the epoxy resin had no redox function.

Then, the mature was applied on a SPCC steel plate (manufactured by Test Piece Co., Ltd.) which had been polished in advance, and carbon fiber in the form of a fiber (“PYROFIL plain weave” manufactured by Mitsubishi Chemical Corporation; carbon fiber cloth) was slacked, and the mixture was impregnated into the carbon fibers. The sample was held for 2 hours at 60° C. as it was in this state, and the epoxy resin was cured (thermally cured) together with dying the solvent contained in the mixture to obtain a test sample.

As doer in FIG. 7 (a), the test sample 73 obtained is formed by bounding a SPCC steel plate 74, and carbon fibers 75 impregnated with an epoxy resin and a polyaniline complex, via the epoxy resin at an adhesive portion 76.

Here, a composition A of the invention (CFRP) is composed of the carbon fibers 75 impregnated with an epoxy ream and a polyaniline complex. The composition A contains 85.59% by mass of the carbon fiber (carbon material), 0.14% by mass of the polyaniline complex (redox substance), and 14.27% by mass of the epoxy resin (polymeric material).

Further, a composite molted body ci the invention is constituted by contacting a first portion composed of the SPCC steel plate 74 and a second portion composed of the carbon fibers (composition A) 75 impregnated with an epoxy resin and a polyaniline complex, with each other at least partially (adhesive portion 78).

The test sample 73 was then immersed in brine (5% by mass aqueous solution of sodium chloride) 77 for 24 hours, as shown in FIG. 7(b). In this case, one side of the adhesive portion 76 in the test sample 73 was immersed in the brine 77, and the other side was held above the liquid level of the brine 77, but since the brine permeated the entire carbon fiber 75 by the capillary phenomenon, the other side of the adhesive portion 76 was also exposed to the brine.

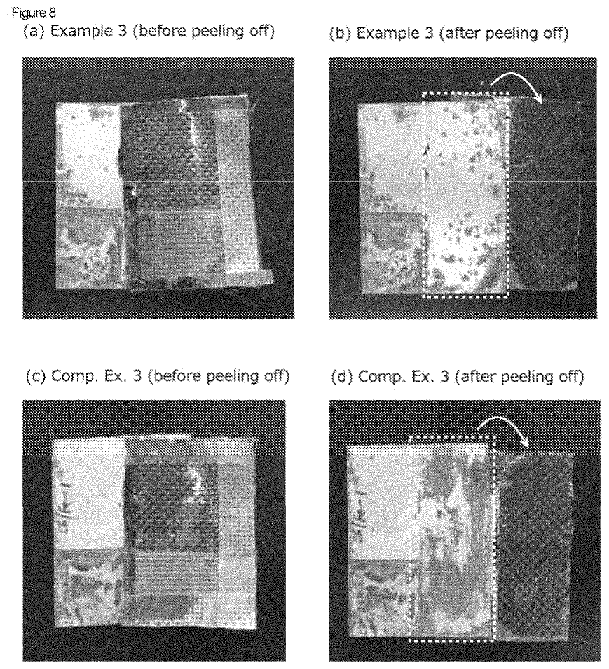

The test sample was then pulled up from the brine, the carbon fibers were peeled off from the SPCC steel plate, and the slate of rust in the cold rolled steel plate was observed. The results are shown in FIGS. 8(a) and (b).

(a) is a photograph of the test sample before peeing off the carbon fibers (after a brine immersion test), and (b) is a photograph of the test sample after peeing off the carbon fibers (a brine immersion test). In (b), the part surrounded by a broken line corresponds to an adhesive portion before peeling.

### Comparative Example 3

A brine immersion test was carried out in the same manner as in Example 3, except that the epoxy resin composition E1 was used alone in place of a mixture of the epoxy resin composition E1 and the polyaniline complex. The results are shown in FIGS. 8(c) and (d).

(c) is a photograph of the test sample before peeling of the carbon fibers (after a brine immersion test), and (d) is photograph of the test sample after peeing off the carbon fibers (a brine immersion test). In (d), the part surrounded by a broken line corresponds to an adhesive portion before peeling.

### 5. Evaluation of Brine Immersion Test 1

From FIG. 8, it can be seen that in Example 3 in which the redox substance was added to the polymeric material, the occurrence of rust (red rust) in the adhesive portion was less than that in Comparative Example 3 in which the addition of the redox substance was omitted.

The area ratio of the rusted portion to the total area of the adhesive portion was calculated to be 12% in Example 3 and 70% in Comparative Example 3.

### 6. Brine Immersion Test 2

### Example 4

To the epoxy resin composition E2 as the polymeric material (raw material), the same redox substance (polyaniline complex) as in Example 1 was added so that the concentration thereof was 1% by mass to obtain a mixture (liquid matter),

Here, the epoxy resin composition E2 contains a main material (epoxy compound “JER828” manufactured by Mitsubishi Chemical Corporation) and a curing agent (carboxylic acid-based; “Nofcure (registered trademark) TN-5” manufactured by NOF CORPORATION; containing 50% by mass of a solvent (propylene glycol monomethyl ether acetate) based on the total amount of the curing agent) in a mass ratio of main material:curing agent=3.0:4.2

Then, the mixture was applied at a thickness of 50 μm on an aluminum plate (Al6016; aluminum alloy) polished in advance, and the mixture was cured and dried at 130° C. for 4 hours to obtain a plating laminate. Then, the mixture was impregnated into carbon fibers in the form of a fabric (“PYROFIL plain weave” manufactured by Mitsubishi Chemical corporation; carbon fiber cloth), and the carbon fibers were stacked on the plating laminate. The plating laminate was held at 130° C. for 4 hours in this state, and the solvent contained in the mixture was dried and the epoxy resin was cured (thermally cured) to obtain a test sample.

The obtained test sample is constituted by bonding the aluminum plate and the carbon fibers impregnated with the epoxy resin and the polyaniline complex, with each other via the epoxy resin at an adhesive portion.

Here, a composition A (CFRP) of the invention is composed of carbon fibers impregnated with an epoxy resin and a polyaniline complex. The composition A contains 85.59% by mass of the carbon fibers (carbon material), 0.14% by mass of the polyaniline complex (redox substance), and 14.27% by mass of the epoxy resin (polymeric material).

Further, a composite mold body of the invention is constituted by contacting a first portion composed of an aluminum plate and a second portion composed of carbon fibers (composition A) impregnated with an epoxy resin and a polyaniline complex, with each other at least partially (adhesive portion).

The obtained test sample was immersed in brine (5% by mass aqueous solution of sodium chloride) for 72 hours, and then subjected to the following impedance measurement (corrosion resistance measurement). The results are shown in Table 2

### <Impedance Measurement>

Measuring instrument: Potentiostat “1287” manufactured by Solartron Analytical
Impedance analyzer “1260” manufactured by Solartron Analytical
   Measurement conditions: Working electrode=the aluminum plate obtained by peeing off the carbon fibers (impregnated with the epoxy resin and the polyaniline complex) from the test sample (residuals of the epoxy resin and the polyaniline complex were left on the surface)

Referenced electrode=Ag/AgCl

Counter electrode=Au

Electrolyte edition=brine (5% by mass aqueous solution of sodium chloride)

Bias voltage=natural potential

Amplitude=10 mV

Frequency=1 Hz

### Comparative Example 4

Impedance measurement was carried out in the same manner as in Example 4, except that the epoxy resin composition E2 was used alone in place of the mixture of the epoxy resin composition E2 and the polyaniline complex. The results we shown in Table 2.

TABLE 2

| | Impedance |
|---|---|
| | after immersion in brine |
| | (Ωcm²) |
| Example 4 | 7.21 × 10¹² |
| Comparative | 1.15 × 10⁷ |
| Example 4 | |

### Example 5

Impedance measurement was carried out in the same manner as in Example 4, except that a SPCC steel plate was used in place of the aluminum plate. The results are shown in Table 3.

### Comparative Example 5

Impedance measurement was carried out in the same manner as in Example 5, except that the epoxy resin composition E2 was used alone in place of the mixture of the epoxy resin composition E2 and the polyaniline complex. The results are shown in Table 3.

TABLE 3

| | Impedance |
|---|---|
| | after immersion in brine |
| | (Ωcm²) |
| Example 5 | 6.85 × 10⁶ |
| Comparative | 1.58 × 10⁴ |
| Example 5 | |

### Example 6

Impedance measurement was carried out in the same manner as in Example 4, except that a zinc plating steel plate was used in place of the aluminum plate. The results are shown in Table 4.

### Comparative Example 6

Impedance measurement was carried out in the same manner as in Example 6, except that the epoxy resin composition E2 was used a one in place rite mixture of the epoxy resin composition E2 and the polyaniline complex. The results are shown in Table 4.

TABLE 4

| | Impedance |
|---|---|
| | after immersion in brine |
| | (Ωcm²) |
| Example 6 | 6.85 × 10⁶ |
| Comparative | 1.58 × 10⁴ |
| Example 6 | |

### 7. Evaluation of Brine Immersion Test 2

From Tables 2 to 4, it can be seen that when the redox substance is added to the polymeric material, the impedance (corrosion resistance) is higher than the case where the addition of the redox substance is omitted, and corrosion can be prevented. Further, it can be seen that such corrosion prevention effect is exhibited for various metals.

### Industrial Applicability

The composition of the invention can be utilized, for example, for a molded body, particularly a molded body which are used in combination with a metal portion.

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly at such modifications are untended to be included within the scope of this invention.

The documents described in the specification and the specification of Japanese application(s) on the basis of which the present application claims Paris convention polarity are incorporated herein by reference in its entirety.

1. A composition comprising a carbon material and a redox substance having a redox potential of −0.2 (V vs. SHE) to 1.5 (V vs. SHE).

2. The composition according to claim 1, wherein the carbon material is a carbon fiber.

3. The composition according to claim 2, wherein the carbon fiber is in one or more forms selected from the group consisting of a chopped strand, a roving, a textile, a non-woven fabric, and a unidirectional material.

4. The composition according to claim 1, wherein the redox substance is a polymer.

5. The composition according to claim 1, wherein the redox substance is one or more selected from the group consisting of a polypyrrole-based polymer, a polythiophene-based polymer, and a polyaniline-based polymer.

6. The composition according to claim 1, further comprising a polymeric material having no redox function or having a redox potential outside of −2.0 (V vs. SHE) to 1.5 (V vs. SHE).

7. The composition according to claim 6, wherein the polymeric material is one or more selected from the group consisting of an epoxy resin, a polyamide resin, a polyimide resin, an acrylic resin, unsaturated polyester, polyurethane, polypropylene, polycarbonate, polystyrene, aromatic polyether, polyarylene sulfide, polysulfone, polyethersulfone, and polyetherimide.

8. The composition according to claim 6, wherein the polymeric material comprises a polycarbonate-polyorganosiloxane copolymer.

9. The composition according to claim 6, wherein the polymeric material comprises syndiotactic polystyrene.

10. The composition according to claim 6, wherein the polymeric material comprises polypropylene.

11. The composition according to claim 1, further comprising a solvent.

12. The composition according to claim 11, wherein the solvent comprises a compound having a hydroxy group and a butoxy group.

13. The composition according to claim 12, wherein the compound is one or more selected from the group consisting of propylene glycol mono-n-butyl ether, propylene glycol mono-ten-butyl ether, propylene glycol mono-isobutyl ether, ethylene glycol mono-n-butyl ether, ethylene glycol mono-tert-butyl ether, and ethylene glycol mono-isobutyl ether.

14. A molded body, comprising the composition according to claim 1.

15. An antirust paint, comprising the composition according to claim 11.

16. A composite molded body, comprising a first portion and a second portion, wherein
the first portion comprises a metal,
the second portion comprises the composition according to claim 1, and
the first portion and the second portion are in contact with each other at least in part.

17. The composite molded body according to claim 16, wherein the first portion comprises a metal or alloy comprising one or more selected from the group consisting of iron, aluminum, zinc, magnesium, and copper.

18. An automobile part, comprising the composite molded body according to claim 16.

19. An aircraft part, comprising the composite molded body according to claim 16.

20. A part for an industrial machinery, comprising the composite molded body according to claim 16.

21. A method of producing the composite molded body according to claim 16, comprising
adjoining the composition to the first portion.

22. The method according to claim 21, wherein the composition further comprises a solvent.

23. The method according to claim 21, wherein in the adjoining of the composition, the composition is adjoined to the first portion by one or more selected from the group consisting of applying the composition to the first portion, immersing the first portion in the composition, and performing insert-molding using the composition for the first portion.

24. A method of suppressing corrosion of a metal portion, comprising
forming a composition portion comprising the composition according to claim 1 to contact with the metal portion at least in part.

25. The method according to claim 24, wherein in the forming of the composition portion, the composition portion is molded to contact with the metal portion at least in part.

26. The method according to claim 24, wherein the metal portion comprises a metal or alloy comprising one or more selected from the group consisting of iron, aluminum, zinc, magnesium, and copper.

27. The method according to claim 24, wherein the forming of the composition portion comprises, adding the composition further comprising a solvent to the metal portion.

28. The method according to claim 24, wherein the forming of the composition portion comprises, adding the composition to the metal portion by one or more selected from the group consisting of applying the composition to the metal portion, immersing the metal portion into the composition, and performing insert-molding using the composition for the metal portion.

29. A sizing material for carbon fibers, comprising a redox substance having a redox potential of −0.2 (V vs. SHE) to 1.5 (V vs. SHE).

30. The sizing material according to claim 29, wherein the redox substance is a polymer.

31. The sizing material according to claim 29, wherein the redox substance is one or more selected from the group consisting of a polypyrrole-based polymer, a polythiophene-based polymer, and a polyaniline-based polymer.

32. The sizing material according to claim 29, further comprising a polymeric material having no redox function or having a redox potential outside of −2.0 (V vs. SHE) to 1.5 (V vs. SHE).

33. The sizing material according to claim 32, wherein the polymeric material is one or more selected from the group consisting of an epoxy resin, a polyamide resin, a polyimide resin, an acrylic resin, an unsaturated polyester, polyurethane, polypropylene, polycarbonate, polystyrene, aromatic polyether, polyarylene sulfide, polysulfone, polyethersulfone, and polyetherimide.

34. Carbon fibers with a sizing material, wherein the sizing material according to claim 29 is added.

35. The carbon fibers according to claim 34, wherein the carbon fibers are in one or more forms selected from the group consisting of a chopped strand, a roving, a woven fabric, a nonwoven fabric, and a unidirectional material.

36. A polymeric material composition, comprising the carbon fibers with a sizing material according to claim 34.

37. A composite molded body, comprising a polymeric material portion and a metal portion, wherein
the polymeric material portion comprises the polymeric material composition according to claim 36, and
the polymeric material portion and the metal portion are in contact with each other at least in part.

38. A method for fabricating the composite molded body according to claim 37, comprising
imparting the polymeric material composition to the metal portion.

39. A method of suppressing corrosion of a metal portion, comprising
adjoining a polymeric material portion comprising the polymeric material composition according to claim 36 to contact with the metal portion at least in part.
